(19) United States
(12) Patent Application Publication
(10) Pub. No.: US 2009/0165078 A1
(43) Pub. Date: Jun. 25, 2009

(54) MANAGING POLICY RULES AND ASSOCIATED POLICY COMPONENTS

(75) Inventors: SRINIVASA C. SAMUDRALA, Irving, TX (US); Gregory W. Cox, Schaumburg, IL (US); John C. Strassner, North Barrington, IL (US)

Correspondence Address: FLEIT, GIBBONS, GUTMAN, BONGINI;& BIANCO P.L., 551 N.W. 77TH STREET, SUITE 111, BOCA RATON, FL, 33487, US

(73) Assignee: Motorola, Inc., Schaumburg, IL (US)

(21) Appl. No.: 11/961,358

(22) Filed: Dec. 20, 2007

(51) Int. Cl. G06F 21/00

(52) U.S. Cl. 726/1

(57) ABSTRACT

A method for modifying policy elements is disclosed. At least one reusable policy element (110) is retrieved from at least one repository (108). The reusable policy element (110) includes at least one of a reusable policy rule (110), a reusable policy rule component (118, 120, 122), a reusable policy rule template, and a reusable policy rule component templates. The reusable policy element (110) is modified by one of editing the reusable policy element (110), and deleting the reusable policy element (110).

### FIELD OF THE INVENTION

The present invention generally relates to the field of policy management and network management, and more particularly relates to a policy management system for managing policy rules and reusable components of policy rules.

### BACKGROUND OF THE INVENTION

Managing policy rules is inherently complex because policy rules are used to control almost all aspects of the functionality of components, devices, and systems that are governed by policy. Recent trends for managing next generation networks, including self-governing autonomic networks, as well as more diverse and complete approaches (e.g., using the Policy Continuum, as described in the co-pending application Ser. No. 11/617,369 entitled “Creating and Managing A Policy Continuum” filed on Dec. 28, 2006, which is commonly assigned to Motorola, Inc. and hereby incorporated by reference in its entirety), increase the need for managing policy rules.

Building a set of policy rules for managing an entire network is complicated by many factors such as requiring collaborative effort from a group of experts. This complication is further increased by the following factors as well: different vendors using different programming languages and management data (i.e., policy rules generally must be able to be translated to each vendor's language and management data); lack of a common data model, which would (1) allow a common representation of policy to be established, (2) allow a common representation of device functionality that is to be controlled to be established, and (3) allow common policy rules to govern heterogeneous functionality of different devices Therefore, to manage different functionality, different people having specific skills are required to work together to define collaborative policies. Current Role Based Access Control (RBAC) Systems do not provide an environment that allows a group of experts who have knowledge of various aspects of the system to collaboratively build a policy rule comprising component Policy Events, Policy Conditions, Policy Actions and Metadata, since said RBAC systems are used only for access control, and not as a means to enable different policy authors to work together.

Therefore a need exists to overcome the problems with the prior art as discussed above.

### SUMMARY OF THE INVENTION

In one embodiment, a method for modifying policy elements is disclosed. The method includes retrieving at least one reusable policy element from at least one repository. The reusable policy element includes at least one of a reusable policy rule, a reusable policy rule component, a reusable policy rule template, and a reusable policy rule component templates. The reusable policy element is modified by one of editing the reusable policy element, and deleting the reusable policy element.

In yet another embodiment another method for modifying policy elements is disclosed. The method includes retrieving at least one reusable policy element from at least one repository. The reusable policy element includes at least one of a reusable policy rule, a reusable policy rule component, a reusable policy rule template, and a reusable policy rule component templates. At least one referencing policy rule component is changed to a contained policy rule component.

An advantage of the foregoing embodiments of the present invention is that policy rules and their associated components (i.e. Policy Events, Policy Conditions, Policy Actions, and Metadata) can be efficiently managed. Note that in the foregoing embodiment, a policy rule component is defined as an object or set of objects that are part of a policy rule. Note further that prior art, in general, uses the term “policy component” in a completely different way than the forgoing embodiments. For example, prior art generally uses the term “policy component” as a means to perform actions on or services associated with policy or a policy rule. Finally, the various embodiments of the present invention use Metadata in a novel way: metadata can be applied to a Policy Rule as well as to any or all of its components (the Policy Rule Components). This use of Metadata provides unparalleled flexibility in the definition, organization, and resulting behavior of Policy Rules and Policy Rule Components.

One example of the prior art usage of “policy component” is given in U.S. Pat. No. 6,834,301, which is hereby incorporated by reference in its entirety. This patent defines several “policy components” that operate on policy in different ways such as the “get policy component” and the “calculate policy component”. Also, the repository here is for network data, not policy rules. This patent does not teach the reuse of policy components. U.S. Pat. No. 7,103,351, which is hereby incorporated by reference in its entirety, gives another example of prior art use of policy components. Here again, the policy component operates on policy rules rather than being a part of policy rules. A policy in this prior art example does not include events. These prior examples represent a fundamental difference between the foregoing embodiments and the prior art. The forgoing embodiments define reusable, managed policy rule components for use in constructing and evaluating policy rules.

Since the Events (that trigger the policy), the Conditions (that determine if actions are to be taken), and the Actions are specified as different components of the policy, it is usually easier to build and manage the policy as discrete components, rather than treating each policy rule as an indivisible whole. This gives the user better control over the content of the policy rule, since the policy rule is, in reality, an intelligent container (See for example page 64 of Strassner, John C.: “Policy Based Network Management”, San Francisco: Morgan Kaufmann Publishers, 2004, which is hereby incorporated by reference in its entirety).

Accordingly, the various embodiments of the present invention treat policy rules and policy rule components as separate entities in the system, and therefore, facilitates applying Role Based Access Control (“RBAC”) to both policy rules as well as policy rule components. The various embodiments of the present invention also enable MetaRules (i.e., rules about rules and rule components) to track and enforce RBAC-based constraints on these policy rules and policy rule components.

The various embodiments of the present invention can also be used to create a repository of Policy Rules, Events, Conditions, Actions, and Metadata. It should be noted that the terms “library” and “repository” can be used interchangeably throughout this discussion. In one embodiment, the term “library” denotes an organized collection of policy rules and policy rule components. The term “library” referred to throughout this discussion, in one embodiment, is a virtual organization, i.e., a physical storage mechanism is not prescribed. Rather, the library can span one or more physical repositories, and uses the Metadata attached to policy rules and policy rule components, as defined by the various embodiments of the present invention, to organize storage, retrieval, querying, updating, and other management functions. A physical repository occupies a single physical location; a virtual repository is a collection of physical repositories that logically appear as a single repository (i.e., an entry can be addressed independent of knowing its location), even though they occupy different physical locations. The various embodiments of the present invention describe how a set of reusable libraries (that can include policy rules, policy elements, and templates for both) can be stored, queried and accessed from a single or multiple, physical or virtual repositories.

The library, in one embodiment, enables users to build reusable components (which can be Events, Conditions, Actions, and Metadata) that can be used in different policies without needing to create new Events, Conditions, Actions, and Metadata separately for each policy. This reusability makes it easier for the network operator to build new policies using the same set of components from one or more libraries since the network operator already understands the behavior of an existing policy rule component. In addition, this reusability drastically reduces the time needed to build a new policy or make changes to older ones while enhancing the reliability and maintainability of the resulting Policy Rules. Note that since reusable library elements can also have attached RBAC permissions and MetaRules, access control and security are also reused.

Another advantage of the foregoing embodiments of the present invention is that the Event, Condition, Action paradigm also facilitates abstraction. This is useful in a scenario where a network technician, who understands alarms in a network and has expertise in using them to build meaningful Events, is allowed to use only the Event part of the policy management application such as (but not limited to) a GUI and/or a script interface. The network technician need not understand the complete policy, and is only concerned with building and managing Events. It is up to the network operator or a system administrator to use these Events to trigger the evaluation of appropriate policies.

Furthermore, the network operator or system administrator need not understand the nuances of the Events, what alarms comprise the Events, how to build Events, etc. He or she only needs to have a high level understanding of why the Events are being generated and what policies should be triggered to handle these Events. The various embodiments of the present invention, therefore, provide an appropriate abstraction to be created between the policy rule and its components. This abstraction enables the user to see only the part of the policy that concerns a particular group of users (e.g., as identified by users having a given role) and reduces the confusion and chances of an error occurring by preventing a user from accidentally changing a policy rule or component that is not in his or her area of expertise. This abstraction also avoids complicating the user's task by presenting the user needless information (e.g., only the portion of the policy rule or component that the user can manage is represented), which helps build efficiency in the user's operation of his or her task.

Yet another advantage of the foregoing embodiments is levels of access can be defined to ensure that different user groups have access to operate only on the part of the policy that is relevant to them. Also, by allowing the users to create new Events, Conditions and Actions on the fly (by using either the default templates or by changing pre-built library components), and moving them to their appropriate libraries, the foregoing embodiments ensure that the policies are extensible.

Finally, the foregoing embodiments allow policies to store references to other policies in a Policy Continuum and navigate thorough the hierarchy. This allows the user to see exactly how the policies are being mapped as they navigate through the Policy Continuum, provided they have the required permissions.

### BRIEF DESCRIPTION OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 is block diagram illustrating a policy management system, according to one embodiment of the present invention;

FIG. 2 illustrates a detailed view of a Policy Rule, according to one embodiment of the present invention;

FIG. 3 shows an example of two different applications of RBAC to the structuring of Policy Rules and their components according to one embodiment of the present invention;

FIG. 4 is a block diagram illustrating MetaRule Constraints, according to one embodiment of the present invention;

FIG. 5-7 are operational flow diagrams illustrating a process editing and/or deleting the Policy Rule components that are present in the Policy Rules or in Policy Rule templates, according to one embodiment of the present invention;

FIG. 8 is an operational flow diagram illustrating a process of editing and/or deleting a Policy Rule or a Policy Rule Template, according to one embodiment of the present invention;

FIG. 9 is an operational flow diagram illustrating a more detailed process of editing a Policy Rule by adding Policy Rule components to a Policy Rule, according to one embodiment of the present invention;

FIG. 10 is an operational flow diagram illustrating a process of determining if a user request to change a Contained component to a Referenced component and vice-versa is valid, according to one embodiment of the present invention;

FIG. 11 is an operational flow diagram illustrating a process of changing a Referencing component to a Contained component, according to one embodiment of the present invention;

FIGS. 12-14 are operational flow diagrams illustrating a process of changing a Contained component to a Referencing component, according to one embodiment of the present invention;

FIG. 15 is an operational flow diagram illustrating a more detailed process for modifying a Policy Rule component in a Policy Rule, according to one embodiment of the present invention;

FIG. 16 is an operational flow diagram illustrating a more detailed process for deleting Policy Rule components, according to one embodiment of the present invention;

FIG. 17 is an operational flow diagram illustrating a more detailed process for adding a Policy Rule component from the Policy Rule to a repository, according to one embodiment of the present invention;

FIG. 18 is a block diagram illustrating a detailed view of an information processing system, according to one embodiment of the present invention.

### DETAILED DESCRIPTION

As required, detailed embodiments of the present invention are disclosed herein; however, it is to be understood that the disclosed embodiments are merely examples of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically.

The term “wireless device” is intended to broadly cover many different types of devices that can wirelessly receive signals, and optionally can wirelessly transmit signals, and may also operate in a wireless communication system. For example, and not for any limitation, a wireless communication device can include any one or a combination of the following: a two-way radio, a cellular telephone, a mobile phone, a smartphone, a two-way pager, a wireless messaging device, a laptop/computer, automotive gateway, residential gateway, and the like.

Also, the term “Policy Events” may be equivalently referred to as “Events”. The term “Policy Conditions” may be equivalently referred to as “Conditions”. The term “Policy Actions” may be equivalently referred to as “Actions”. The term “Policy Rules” may be equivalently referred to as “Rules”. The term “policy element” is used to generally refer to one or more of a policy rule, a policy rule component, a policy rule template, and a policy rule component template. Also, as discussed above, the terms “library” and “repository” can be used interchangeably throughout this discussion.

Policy Management System

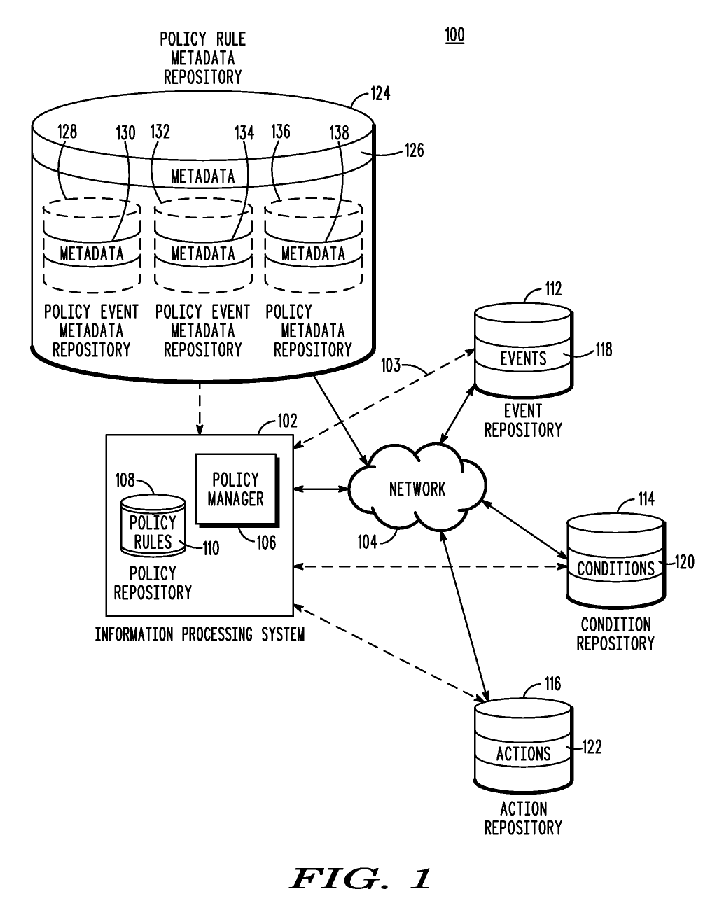

According to an embodiment of the present invention as shown in FIG. 1 a policy management system 100 is illustrated. It should be noted that FIG. 1 illustrates only one configuration of the policy management system 100. For example, one or more of the components in the policy management system 100 can reside on a single system and are not coupled to one another via a network 104. Stated differently, the policy management system 100 is independent of repository type and location.

FIG. 1 shows one or more information processing systems 102 that are communicatively coupled to the policy management system 100, either locally (in the same system using a messaging service 103) and/or externally via at least one network 104 such as a Local Area Network (“LAN”), Wide Area Network (“WAN”), or another network configuration. The network 104 can be a wired network or a wireless network. The information processing system 102 can be a workstation, server, desktop computer, notebook, or other type of system.

The information processing system 102, in one embodiment, includes a policy manager 106. The policy manager 106 manages policy rules and their associated components. The policy rule/policy rule component management process is discussed in greater detail below. The information processing system 102, in one embodiment, includes a policy repository 108 for storing policy rules 110. As discussed above, a library is a virtual organizational structure that resides within a repository. It should be noted that the policy repository 108 is not limited to residing within the information processing system 102. For example, the policy repository 108 can reside outside the information processing system 102 and be coupled through the network 104 or messaging bus 103. Likewise, the policy manager 106 is not limited to residing within the information processing system 102. For example, the policy manager 106 can reside outside the information processing system 102 and be coupled through the network 104 or messaging bus 103.

The policy manager 106 is also communicatively coupled to an event repository 112, a condition repository 114, an action repository 116, and a metadata repository 124. The use of these four repositories provides maximal reuse while keeping their management processes separate. However, one or more embodiments of the present invention also include a simpler case where a fewer number of repositories are used to store policy rules and their policy rule components. In the example of FIG. 1 each of these repositories 112, 114, 116, 124 are communicatively coupled to the policy manager 106 via the messaging bus 103, but can also be communicatively coupled to the network 104. It should be noted that one or more of these repositories 112, 114, 116, 124 can also reside within the information processing system 102.

The event repository 112 comprises Events 118; the condition repository 114 comprises Conditions 120; the action repository 116 comprises Actions 122; and the Metadata repository 124 comprises Metadata 126. Also, policy rules, policy rule components, policy rule templates, and policy rule component templates can be stored across different repositories than one another. These repositories can be of a different physical entity or a different logical partition of an original physical entity. This enables both physical and logical security to be exercised on as a granular basis as possible. Policy rules, policy rule components, policy rule templates, and policy rule component templates can be collectively referred to policy elements.

Optionally, the policy rule Metadata repository 124 and policy rule Metadata contents 126 can be supplemented by having a policy event Metadata repository 128 and contents 130, a policy condition Metadata repository 132 and contents 134, and a policy action Metadata repository 136 and contents 138. Each of these repositories 112, 114, 116, 124, 128, 132, 136 and their respective contents 118, 120, 122, 126, 130, 134, 138 are discussed in greater detail below. Note, however, that just as with policy rule Metadata 126, the policy rule component Metadata 130, 134, 138 do not have to be present, nor do they have to be located in separate repositories (i.e., they could share the policy rule repository 124).

Policy Rules and Their Components

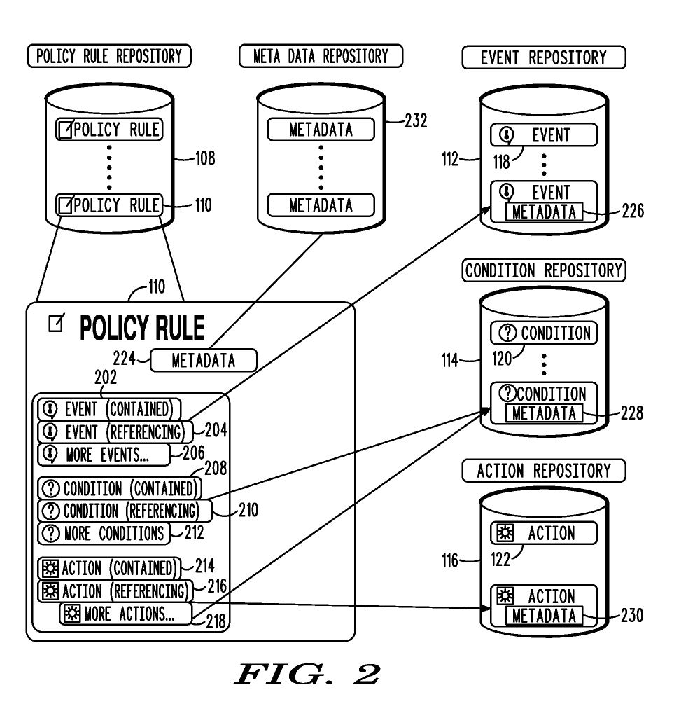

As discussed above, one embodiment of the present invention comprises a policy management system 100 for managing policy rules 110 and the policy rule components 202-218 and 224 (Events, Conditions, Actions, and Metadata) (FIG. 2) of policy rules 110. Managing policy rules 110 can include creating, editing, organizing, deleting, querying, executing, and representing policy rules 110, its Metadata 224, and its policy rule components 202-218 and their Metadata 226-230. Since a policy rule 110 is made up of a set of policy rule components 202-218 and their Metadata 226-230, the above definition can be extended to reusing policy rule components 202-218 with their Metadata 226-230 and policy rules 110 with their Metadata 224; to construct more complex policy rule components 202-218 and their Metadata 226-230 and policy rules 110 and its Metadata 224. For example, a complex policy rule component can be constructed out of a set of simpler policy rule components (e.g., a complex policy condition comprising multiple simple conditions) and a policy rule 110 can be created from a set of policy rule components 118, 120, 122, 126.

Metadata 224, in one embodiment, is used to describe the behavior and characteristics of a policy rule. In addition, each policy rule component, in one embodiment, includes its own Metadata 226, 228, 230 to describe the behavior and characteristics of the particular Policy Events, Policy Conditions and Policy Actions that a given policy rule uses. Note that each metadata 224, 226, 228, 230 behaves as a reusable component (that can be stored in a separate repository/), and can be used across multiple policy rules similar to the reusability of a policy rule component 118, 120, and 122.

Conceptually, a policy rule 110 can be thought of as an intelligent data container that serves to aggregate one or more policy Events 118, one or more policy Conditions 120, and one or more policy Actions 122. For example, Events 118, Conditions 120, and Actions 122 can be composed independent of each other and hence, should not store references to each other. Therefore, the policy rule 110 acts as a container for collecting Events 202, 204, 206, Conditions 208, 210, 212 and Actions 214, 216, 218 and provides these references automatically. Throughout this discussion, Policy Events 118, Policy Conditions 120, and Policy Actions 122 are referred to as Policy Rule Components. In addition, a policy rule 110 itself has additional data and metadata 224 that enable generic and/or rule-specific behavior to be associated with a policy rule 110, just as each of the policy rule components 118, 120, 122 has metadata 226, 228, 230, respectively. For example, the metadata 224 can indicate the appropriate context in which the policy rule should be applied.

Events 202, 204, 206 are used to decide when to trigger the evaluation of the Condition(s) 208, 210, 212 of the policy. The Conditions 208, 210, 212, in one embodiment, are used to test the state of the system being monitored and determine which action(s), if any, are to be taken. The Actions 214, 216, 218, in one embodiment, define any operations to be performed to either maintain the current state or transition the system to a new desired state. Actions can optionally be specified for both the occasion when the result of the condition clause is TRUE (pass actions) and when the result of the condition clause is FALSE (fail actions). The policy manager 106 allows a policy author to organize these policy rule components (Events, Conditions and Actions) directly into separate repositories 112, 114, 116 and optionally, to construct libraries of policy rule components. As discussed above, the Policy Rule 110 has its own dedicated Metadata 224, while the Events, Conditions, and Actions each have their own dedicated Metadata 226, 228, 230. The policy rule Metadata 224 and policy rule component Metadata 226, 228, 230 can be stored in any combination of a single repository or up to four repositories, as explained above.

FIG. 2 illustrates a more detailed view of a policy rule 110. As shown in FIG. 2, a policy rule 110 comprises metadata 224 that describes the behavior and characteristics of the policy rule 110, enables generic and/or rule-specific behavior to be associated with the policy rule 110, and indicates how policy rule Components are used with the policy rule 110. FIG. 2 also shows that the policy rule 110 includes one or more Policy Events 118, Policy Conditions 120, and Policy Actions 122 (these three objects are collectively called Policy Rule Components). These Policy Rule Components 118, 120, 122 can either be Contained components (i.e., fully defined in the policy rule 110 itself and used exclusively therein) or Referencing components (i.e., components that reference other components, where the components that are Referenced are called Referenced components and can be used in multiple policy rules). Referenced Components may reside in a Policy Rule, a Policy Rule template (in which case the Referenced Component is a Contained component with respect to the Policy Rule or Policy Rule template it resides in, but is a Referenced Component with respect to the Referencing Component that refers to it) or independently in a separate repository.

For example, FIG. 2 shows the policy rule 110 including a Contained event(s) 202, a Referencing event(s) 204, and additional events 206. The policy rule 110 also includes a Contained condition(s) 208, a Referencing condition(s) 210, and additional conditions 212. FIG. 2 also shows the policy rule 110 including a Contained action(s) 214, a Referencing action(s) 216, and additional actions 218. Each of the Contained components 202, 208, 214 is fully defined within the policy rule 110, whereas each of the Referencing components 204, 210, 216 is referencing other components outside of the policy rule 110. The components referenced by these Referencing components 204, 210, 216, in one embodiment, are each stored in their respective repository(s) 112, 114, 116.

However, it is not necessary that a Referenced component be stored in a physically separate or even a logically separate repository. In some cases a Referencing component might reference another component stored in the same policy rule 110. Thus, there are three types of components used the various embodiments of the present invention: (1) a Contained component, which is completely defined in the policy rule 110 that includes it; (2) a Referenced component that is stored in a repository (as opposed to embedded within the policy rule like Contained components); and (3) a Referencing Component, which is also included in the policy rule that includes it, but which references either a Contained or a Referenced component.

In various embodiments of the present invention, Referencing components are stored in the component or rule that defines them. In some embodiments of this invention, Referenced components also store “back-pointers” to their referencing components. The use of such “back-pointers” is an application-specific design decision, and involves tradeoffs between storage and efficiency. This facilitates management and maintenance of policy rules and policy rule components. For example, if a particular condition needs to be changed, then in one embodiment, all that is needed is to edit that particular condition once. All users of that condition (e.g., all the policy rules that use that condition) are automatically updated, since they include references to the (edited) condition, not the actual condition itself.

The reason for storing links in both directions is to enable a Referenced component that is updated or deleted to broadcast this change to all the Referencing components using it. This allows the Referencing components to be changed near real time with no action from the user. In another embodiment, a Referenced component can simply broadcast a message indicating that it has been changed (instead of broadcasting the change itself). This notification causes the Referencing component, for example, to indicate to the user that a change has occurred and that the user needs to refresh his/her view of the component.

Thus, a policy rule 110, which comprises metadata 224, 226, 228, 230, Policy Events 202, 204, 206, Policy Conditions 210, 212, 214, and Policy Actions 214, 216, 218 as discussed above, can be built collaboratively by a group of experts who have knowledge of various aspects of the system. Note that policy rules are not inherently restricted in size or complexity. Indeed, large systems with complex goals may typically require very complex policy rules. This complexity engenders the need for team authorship of policy rules. One embodiment of the present invention, addresses this need by enabling different users to work on all or part of a policy rule 110. For example, one set of users can focus on the alarms and events that are relevant to monitor the system or its components.

Similarly, another set of users can focus on the conditions that are to be checked for correctly deducing the state of the system being monitored, while a third set of users can focus on the actions to be taken to either maintain the current state or transition the system to a new desired state. In an alternate example, one set of users can focus on the events, conditions and actions associated with a particular type of managed entity (e.g., a particular type of router made by one set of vendors) while another set of users can focus on the events, conditions, and actions associated with another type of managed entity (e.g., a switch made by a different set of vendors). The various embodiments of the present invention also facilitate coordination between these users who are experts in specific equipment types rather than policy rule component types as in the prior example.

It should be noted that in FIG. 2 the Events 118, Conditions 120, Actions 122, and policy rules 110 are shown in their respective libraries and also as part of the policy rule(s) they belong to only for illustrative purposes. Exploring a policy rule 110 shows the Events 202, 204, 206, Conditions 208, 210, 212, Actions 214, 216, 218, and the Metadata for each (224, 226, 228, 230 respectively) that make up that policy rule 110, assuming that the user has appropriate access to see its components. Other, more privileged, users are able to perform other actions according to the capabilities defined by their roles to the policy rule and their components. The details of these Events 202, 204, 206, Conditions 208, 210, 212, and Actions 214, 216, 218 and the Metadata for each (226, 228, 230 respectively) may be shown to the user depending on the user's privileges. These additional details include viewing and possibly editing the definition of each component, associated metadata, and any sub-Events, sub-Conditions and sub-Actions that are contained by the corresponding Event, Condition, or Action, respectively, as well as creating Referenced and/or Contained components, and performing operations on the Referenced and Contained components as previously discussed.

The paradigm used for representing components of a policy rule 110 also applies to the sub-components of Events 202, 204, 206, Conditions 208, 210, 212, and Actions 214, 216, 218. This paradigm allows simple and/or composite policy rules, Events, Conditions, and Actions as discussed in the DEN-ng information model to be constructed. The DEN-ng information model employs UML to describe the entities involved in policy (e.g., Events, Conditions, and Actions) as object-oriented classes using associations and association classes to describe the relationships between policy entities. This provides an extensible structure for policy management that can be used in conjunction with various embodiments of the present invention. The DEN-ng information model is discussed in greater detail in Strassner, John C.: “Policy Based Network Management”, San Francisco: Morgan Kaufmann Publishers, 2004.

Since the Events 202, 204, 206, Conditions 208, 210, 212, Actions 214, 216, 218, and Metadata 224 also store cross-references to the policy rules 110 that they are contained in, these Events 202, 204, 206, Conditions 208, 210, 212, and Actions 214, 216, 218 can also be explored to find all the policy rules that contain them. Similarly, the Event, Condition, and Action Metadata 226, 228, 230 store cross-references to their Events 202-206, Conditions 208-212, and Actions 214-218. This allows the user to examine the hierarchy in both a top-down as well as a bottom-up fashion. For example, in one embodiment, the user can browse a policy rule 110 and navigate down the hierarchy to see the details of its components (Events, Conditions, Actions, and Metadata) of the policy rule 110 (including symbology to differentiate whether a component is Contained or Referenced). The user can also navigate up the hierarchy of a policy rule component (for example an Action) and find all the policy rules 110 that use that particular component (in this case, the user can find out all the policy rules 110 that use this particular Action). This allows the user to make changes to a particular component knowing which policy rules are to be impacted by those changes.

Besides this complexity involved in building policy rules 110, a Policy Continuum specifies various levels for a policy rule 110. Lower-level policies tend to include more specific detail in a narrower scope (e.g., they are usually confined to govern functionality of a specific device), while higher-level policies (e.g., “John gets Gold Service”) by definition require significant subsequent effort to translate them to a form suitable for consumption by the target(s) of the policy rule 110.

A critical component of managing policy rules 110, in one embodiment, is governing access privileges to each policy rule. Since policy controls functionality, access should be in general carefully controlled. This includes 1) use of a mechanism such as RBAC to ensure that only the relevant subset of policy rules are exposed to the people using and/or managing the policy; 2) providing different access levels to a person or group of people based on their roles; and 3) enabling different parts of the policy rule (i.e., policy rule components) to be managed by different roles (e.g., enabling one set of people to develop (reusable) policy events, conditions and actions, and another set of people to develop policy rules that use these reusable policy rule components).

For example, referring back to FIG. 2, this figure shows that different repositories 118, 120, 122 can be used to build a policy rule 110. Therefore, one embodiment of the present invention enables the components 202-218 of the policy rule (as well as the policy rule 110 itself) to each impose their own access control restrictions. This can be performed by associating different Role Based Access Control rules to each of the different repositories 110, 112, 114, 116, 124, 128, 132, 136 that include the policy rule 110 and/or components 202-218 of the policy rule 110, as well as the policy rule metadata 224 and/or the policy rule component metadata 226, 228, 230. FIG. 2 shows this application of RBAC according to one embodiment of the present invention.

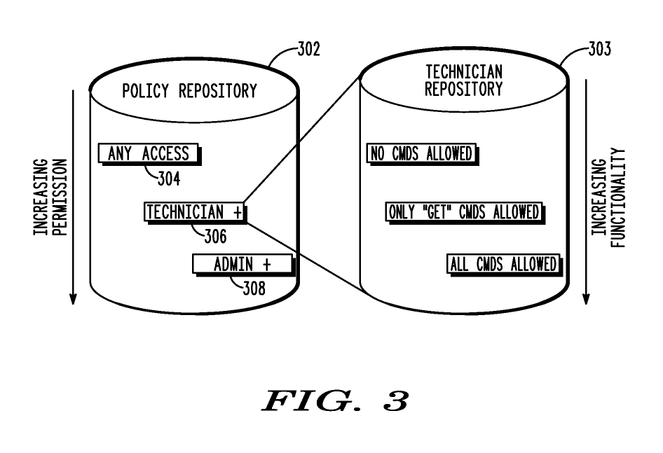

FIG. 3 shows an example of two different applications of RBAC with respect to the structuring of policy rules and their components according to an embodiment of the present invention. The Policy Repository 302 on the left uses a hierarchy to define individual and role access control permissions. With respect to the Policy Repository 302, decreasing levels in the repository 302 represent the RBAC hierarchy, which further restricts access. For example, Policies placed in the “Any Access” partition 304 of the Policy Repository 302 can be accessed by anyone, whereas Policies placed in the “Technician+” portion 306 need at least a “Technician” role to be accessed. Similarly, Policies placed in the “Admin+” role 308 need at least an “Admin” role to be accessed, where “Admin” has more permissions than “Technician” (i.e., the role “Admin+” is a subclass of the role “Technician+”).

Note that in the above example, a “partition” is a specific region of a repository set aside for a particular purpose. The various embodiments of the present invention can also achieve a similar function by associating storage locations and/or components with tags (e.g., metadata) that provide the same functionality. Furthermore, this discussion assumes than an embodiment uses the role-object pattern. This pattern is used to adapt the same object to different client needs transparently by attaching one or more role objects to the original object. Each context is kept separate by the different role objects. This role-object pattern is further discussed at (www.cs.uiuc.edu/users/hanmer/PLoP-97/Proceedings/riehle.pdf), which is hereby incorporated by reference in its entirety. The DEN-ng information model uses this pattern throughout its design. Thus, this approach uses a hierarchy to provide increasing role access control levels. By placing policy rules 110 and their components 202-218 into appropriate levels in a hierarchy, the policy rule 108 and its constituent components 202-218 are protected.

FIG. 3 also shows an approach in which a hierarchy is used to provide increasing functionality. The technician repository 303 shows decreased levels in the repository 303 that represent the application of RBAC permissions, which add stability to perform more functionality. This is similar to the first approach, but uses role functionality (e.g., the “power” or “complexity” or “knowledge required” of the command) in the same way that the first approach used role authority (e.g., how “privileged” was the user). These two approaches are examples; other approaches can be defined as well. By enabling a policy rule 110 and its constituent components 202-218 to be placed in different storage areas that are themselves governed by RBAC rules (or alternatively, embedding tags in the storage locations and/or objects to provide this functionality), the policy rule 110 and its components 202-218 respect the restrictions defined by RBAC. Current Policy management systems do not provide this functionality. In addition, one embodiment of the present invention provides an innovative mechanism for enabling metadata 224-230 to be used to ensure the integrity of the placement of policy rules 110 and their components 202-218.

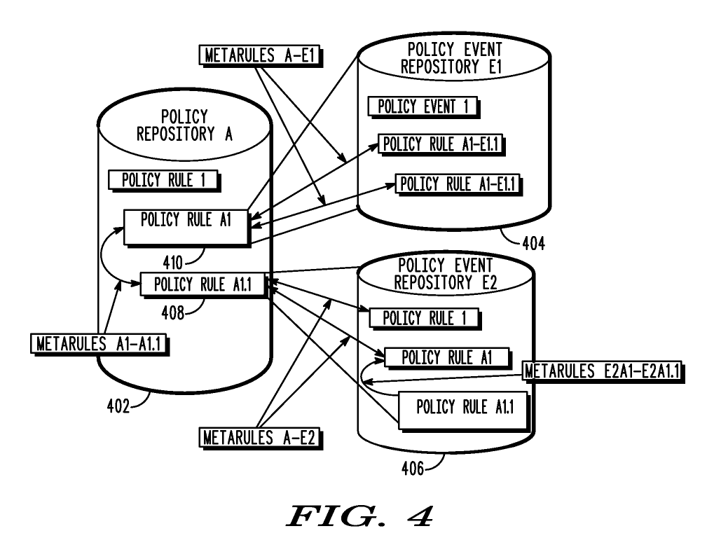

FIG. 4 shows this application of metadata according to one embodiment of the present invention. FIG. 4 illustrates the concept of “MetaRule Constraints”. In this approach, constraints are defined that realize the RBAC concepts being enforced. FIG. 4 shows a Policy Repository A 402, a Policy Event Repository E1 404, and a Policy Event Repository E2 406. Each of the Policy Event Repository E1 404 and the Policy Event Repository E2 406 are communicatively coupled to the Policy Repository A 402. A policy rule A1.1 408 is a sub-rule of policy rule A1 410 (meaning that policy rule A1 410 is not completely evaluated and executed until policy rule A1.1 408 has been evaluated and executed).

Hence, there is a constraint between policy rule A1 410 and policy rule A1.1 408. Now, if policy rule A1 410 is placed at a certain level in the RBAC hierarchy, a MetaRule (which is a policy rule governing a policy rule) can be defined for ensuring that the access control defined for policy rule A1.1 408 is at least at the level of the access control for policy rule A1 410. (Note that this does not need to occur all the time; however, there exists situations in which it is beneficial to protect the integrity of the “inner rules” (or components) from those of the “outer rules” (or components). One embodiment of the present invention comprises this capability.

Consider the task of using policy rules to control the construction of a router configuration. Portions of the router configuration are the same regardless of where the router is located or how it is used (e.g., defining and using the same access control list). However, other portions are specific to how the router is used (e.g., traffic engineering or peering with specific autonomous systems). Suppose the organization using policy rules want to also use RBAC to ensure that only qualified personnel edit certain portions of the router configuration (e.g., the traffic engineering portion). One embodiment of the present invention enables this capability as follows. The policy manager 106 constructs a set of repositories according to the desired personnel roles. The policy manager 106, places policy rules 110 and their constituent components 202-218 in appropriate repository positions (i.e., partitions) or embeds metadata in the storage locations and/or policy objects to ensure proper access control. The policy manager 106 defines metadata 224-230 that ensure that each policy rule 110 and policy rule component 202-218 are constrained according to their function (e.g., a rule originally placed in a restricted storage area generally cannot be placed in a less restricted storage area unless an administrator with appropriate permissions does so; one such method is to create a new rule from the existing rule and change its permissions).

The following is a more detailed discussion of Contained policy components and Referenced policy components. To get better performance out of the policy management system 100, a policy rule 110 can also directly contain Event 202, 204, 206, Condition 208, 210, 212, and Action 214, 216, 218 components instead of referencing them. Referring back to FIG. 2, Events 202, 204, 206, Conditions 208, 210, 212, and Actions 214, 216, 218 are of two types; Contained components and Referencing components. As discussed above, Contained components are Policy Components that are defined and described in the policy rule 110 itself, while Referencing components are components that identify Referenced components defined and described outside the Referencing Component.

These Referenced components are normally stored in a separate logical repository, but in some cases they can also be stored elsewhere in the same policy rule 110. This implies that a Contained component residing in a policy rule 110, in one embodiment, can be referenced by another Referencing component residing in the same policy rule 110. This referencing can occur in a scenario where a policy Event triggers some action in a policy rule 110 and can also be a sub-event in another Event in the same policy rule 110. The Contained component can also be referenced by another Referencing Event in another policy rule and hence, is both a Contained Component and a Referenced Component. It should be noted that a Contained Component cannot be a Referencing Component because they are mutually exclusive. Contained components are wholly contained within the containing component. They do not reference or refer to other components anywhere in the system 100. The details of these components are completely specified in the component itself.

A user having write access to a policy rule 110 can change the content of Contained components present in that policy rule 110. A Contained component can also be referenced by another Referencing component. For example, an Event can be a Contained component for a repository 112 (or even a policy rule 110) in which it resides, but is also a Referenced component for a policy rule 110 that refers to it using its Referencing component (which in this example is a policy Event in the policy rule that refers to this policy Event in the repository or policy rule).

The references of the Referencing components can be modified (they can be made to refer to another component of the same type), but the content of the Referenced components can only be changed, in one embodiment, by a user having write access to that particular Referenced component. However, when the Referenced component is modified, all the Referencing components that refer to this component are updated.

This approach gives various embodiments of the present invention two advantages. Using Referencing components in a policy rule 110 allows Events, Conditions, and Actions to be composed independently of each other and independent of the policy rules 110 that may use them. Referencing components also allow policy components to be referenced by multiple policy rules, thus increasing reusability and flexibility. At the same time, using Contained components, which are defined in the policy rule 110 itself allows the policy rule 110 to run more efficiently because additional accesses required to retrieve the Referenced component by the Referencing component are avoided. In addition this does not require edit permissions beyond the policy rule 110 itself. This method improves the performance of the system by reducing the time needed to look-up and access the Referenced component. Hence, the policy management system 100 of the various embodiments of the present invention allows Events, Conditions, and Actions to be linked either by reference (to improve flexibility) or by containment (to improve performance). This allows the system 100 to balance flexibility versus performance, enabling these two factors to be fine-tuned to suit the specific needs of different applications.

For example, in an implementation based on one embodiment of the present invention, a user might create several policies using Referencing components in a policy rule 110 that reference components in one or more repositories. While testing the policies, the user may continue to use the Referencing components for flexibility, giving the user the ability to make changes in one place that are automatically reflected in all affected policies. After the test phase, once the policies are ready to be deployed, a privileged user can convert these Referencing components into Contained components. When the user does this, a copy of the each of the components Referenced by the Referencing components is made and stored automatically in the corresponding policy. This reduces the time spent to look up the Referenced components and drastically improves the system performance. This gives the user flexibility (while testing) and performance (at deployment) when they are needed.

When a user converts a Referencing component to a Contained component, the references to the old components are not lost; the system 110 still stores the references to the old components. There are two reasons for keeping this seemingly useless reference. First, this reference to the old component allows the user to verify, at a later point of time, if there are any differences between the current Contained and the old Referenced components and resolve them. Second, this reference to the old component also allows the user to change the Contained component back to a Referencing component. Hence users are able to convert Referencing components into Contained components and vice-versa. These old references are referred to as soft links. The soft links are active (i.e. both the Referenced component and the Referencing component know about it) whenever a Referencing component has been converted to a Contained component. If a Referencing component is changed to reference to another Referenced component, the soft link is not active. However, the soft link is still stored in a stack to allow the user to undo the operation and point back to the old Referenced component.

For example, assume a scenario where a user decides to change the Referenced components of a Policy to Contained components to realize better performance. After some performance tests, the user may find out that the author of the Action components in the policy rule has made some more changes that need to be synchronized with the current policy rule. Then, in one embodiment, the user is allowed to check for differences between the Contained component and the corresponding formerly Referenced component in the appropriate repository. The user can also be given the option of applying the changes in the Referenced component to the Contained component. This process is discussed in greater detail below.

In another embodiment, the user may make some changes to the Contained component and push these changes to the formerly Referenced component (if the user has sufficient privileges to modify the component repository). This way the changes get propagated to all the policy rules using that component. In yet another embodiment, the user may change the Contained component into a Referencing component and then ask the author of the Referenced component to make the required changes. When the author makes the required changes to the Referenced component, the Referencing component in the policy rule 110 gets updated automatically.

When a Contained component (that was previously a Referencing Component) is changed back to a Referencing Component and a change exists between the formerly Contained component and the newly defined Referenced component, one embodiment of the present invention provides the user two options. First, the contents of the newly defined Referenced component are adopted into the Contained component, thus losing the changes stored in the Contained component from when it was first a Referencing Component. Second, the changes in the Contained component are pushed into the newly defined Referenced component (provided the user has sufficient privileges). In the second option, if the user chooses to modify the Referenced component, this component sends a notification about the change to all other Referencing components. This allows the other Referencing components to get updated or forcing an update on all the Referencing components, depending on the preferences set by the user.

Other Contained components that had previously Referenced this changed Referenced component are also be notified (since the Referenced component stores references to all the components that reference them, including the ones that have active soft links) about this change, thus giving them an option to synchronize with the latest data. An implementation might also choose to turn this feature off and have the user check for any changes made components that were previously Referenced by the current component only when he/she wishes to do so. The above scenarios covering the change from a Contained component to a Referencing component and vice-versa are discussed in greater detail below. The actual Events, Conditions, Actions, and policy rules 110 can be stored in a repository or a set of repositories 108, 112, 114, 116 (abstracted away from the user so that they appear to be stored in a single repository) along with all their references, or assembled at edit time and stored as an atomic unit.

Policy Rules and the Policy Continuum

One embodiment of the present invention also provides details on how various policies generated in accordance with the Policy Continuum are to be stored, represented, and managed. (See for example a book by one of the co-inventors, “Policy-Based Network Management”, John C. Strassner, ISBN 1-55860-859-1, Morgan Kaufmann Publishers, Copyright 2004 at P. 23, FIGS. 1-8, which is hereby incorporated by reference in its entirety.) For multiple policies in the Policy Continuum, each policy can be a lower level elaboration of one or more higher level policies, and can also be a higher level abstraction of one or more lower level policies. (Note that Policy Level Continuum “levels” and “views” are used interchangeable throughout this discussion.) In such a case, these policies generally store the references for all the higher level policies (referred to as Parent policies or policy rules) and also store the references for or comprise of all the lower level policies (referred to as Child policies or policy rules).

A child policy rule supports and/or adds details to the parent policy rule(s) that it supports. The information about these policies, which are at different levels in the Policy Continuum, is stored in repositories similar to the Events, Conditions, and Actions discussed above. Along with the information (metadata) about the policies, the references to its parent and child policies are also stored in a policy. Following the same paradigm discussed above, parent policies can either reference (for flexibility) or embed (for performance) child policies. Also, as with Events, Conditions and Actions in a policy rule, a user is allowed to change Referenced child policies into Contained child policies and vice-versa.

In one embodiment, a graphical user interface enables each policy to be stored in its own container. Each container can be a portion of a repository or library, as explained above. Using this graphical user interface, exploring a policy shows the Parent or the Child policies in the hierarchy, depending on what the user wants to see. This allows the user to navigate the hierarchy in both top-down and the bottom-up directions, depending on the permissions given to him/her.

Examples of Policy Rule Creation

The following example discusses how a group of users can build a policy from scratch, assuming that the users have reached a consensus on the functionality of the policy according to one embodiment of the present invention. A network operator (who has knowledge about the network and the Events in the network, such as Alarms) logs into the system 100 with his or her credentials. This example's network operator belongs to the user group that has permissions to read policies and edit or create the Event components in the policy rule set. This network operator is a system Event specialist who does not compose policy rules 110, but rather exclusively builds Events used in policy rules 110 composed by other experts. In order to create this Event, the network operator uses the managed entities and the attributes that are available to him. Note that this is a realization of RBAC restrictions.

Other network operators who specialize in building Conditions and Actions do the same for their respective components. The operators log in and create Conditions and Actions and store them in the repository or the library. The network operators in this example have read-write access only to the components created by them in their respective libraries; all other dependencies are governed by appropriate RBAC policies. For example, it may be necessary for an editor of Conditions and Actions to see (but not be able to modify) Events.

The network administrator then logs on and creates policies using the library components (Events, Conditions, and Actions) composed by the network operators cited above. The network administrator may also be allowed to compose or edit Event, Condition, and Action components. This enables the network administrator to hand-tailor reusable components to his or her application-specific needs. The network administrator can also edit default Events, Conditions, and Actions that are provided as a starting point for a new policy rule 110. This allows the administrator to use existing policy rules as a basis for new policy rules 110.

Another embodiment of the present invention implements the concept of a template. A template is a pre-defined policy rule 110 or policy rule Component (Event, Condition, or Action) with default parameters that provide a foundation to help users build policy rules 110 and policy rule Components quickly. Template policy rules can also be provided for various general contexts (e.g., edge router vs. core router policy rules). A template policy rule or a template policy rule Component is no different from a policy rule 110 or a policy rule Component, respectively. The purpose of a template policy rule, in one embodiment, is to speed development and to ensure structural consistency of policy rules 110 and policy rule Components by providing a standardized structure that can then be customized as needed. After creating a policy rule 110 or a policy rule Component, a user can mark that Component as a template, effectively telling other users of the system that this template can be modified and reused to accomplish a function or set of functions. Components that are marked as templates can be grouped together physically (e.g., in the same storage partition) and/or logically (e.g., in the same virtual container) to make it easier to find them.

For example, in one embodiment, a user can search for all available templates for a core-router policy rule template and make some changes to the default parameters to build a core-router policy rule quickly. The user can also make changes to the Events, Conditions, and Actions provided in this template. This standardizes how policies are built to control routers whose role is “core”.

In another implementation, a user can use a Voice Service Quality Template Events to create policy Events that can be used to monitor the Voice Service Quality Key Quality Indicator (“KQI”) in a network. The user can change the default parameters in this template event to create new Policy Events that can be used to build new policy rules (e.g., to add new Key Performance Indicators (KPIs) and/or KQIs to the Voice Service Quality definition for the policy rules to monitor and take action on). An administrator (or a user who has write access to the repository) can also add the Event, Condition, and Action components that he or she has created to the library to be reused by other network administrators to create new policy rule sets. For example, in one embodiment, an administrator, after creating a policy rule 110 to manage an edge router using a template, can copy the policy Event used in the policy rule to the policy Event repository. This Event can then be reused by other policy rules 110, for example to detect any events that may affect the Quality of Service in the network. After creating the policy rules 110, the user can then navigate the hierarchy of the policy rule set and the policies in the Policy Continuum, both top-down and bottom-up, as discussed above.

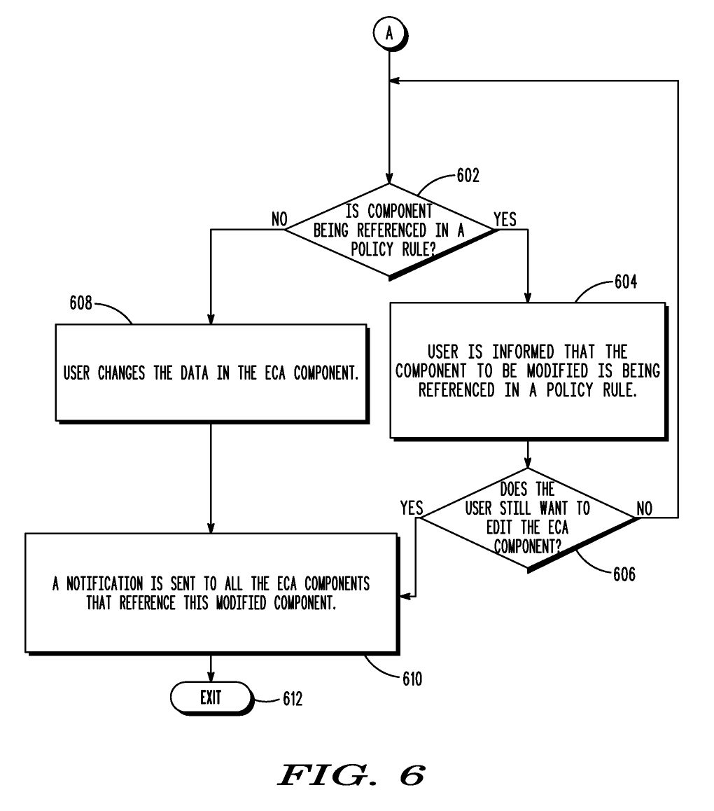

The operational flow diagrams of FIGS. 6-8 illustrate how a user is allowed to edit policy rule components. FIGS. 6-8 illustrate the process of editing policy rule components that are present in a repository (e.g., policy rule components that are being referenced by other policy rule components and/or policy rules 110). The discussion on editing a policy rule 110 encompasses the process of editing policy rule components present in the policy rules 110 and changing a Contained component to a Referencing component and vice versa.

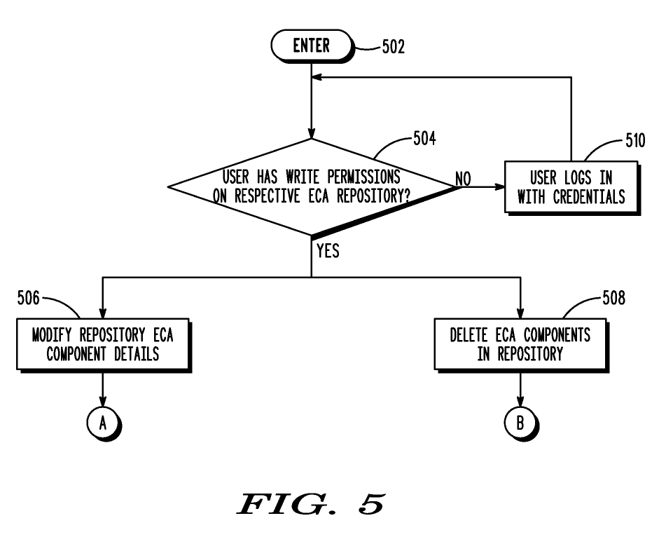

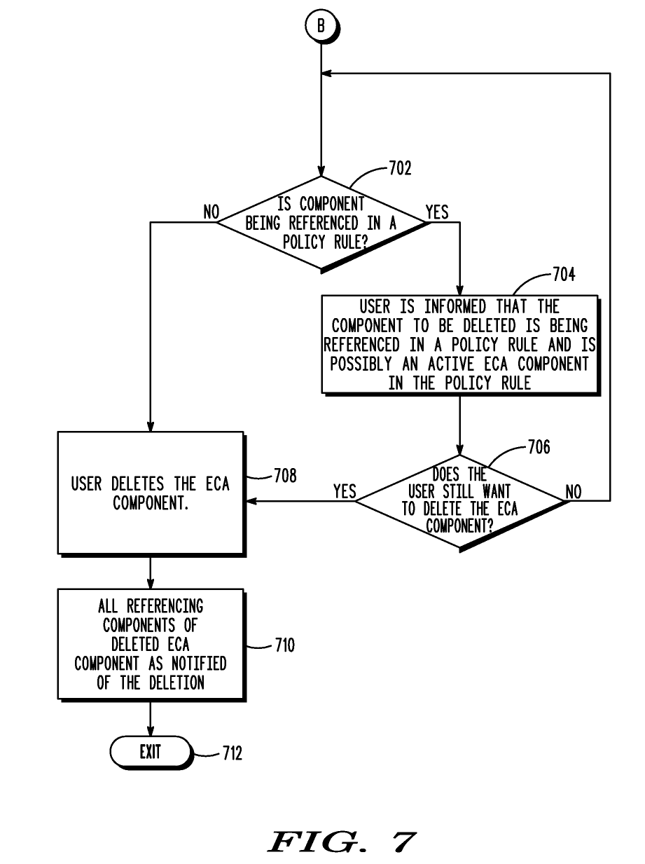

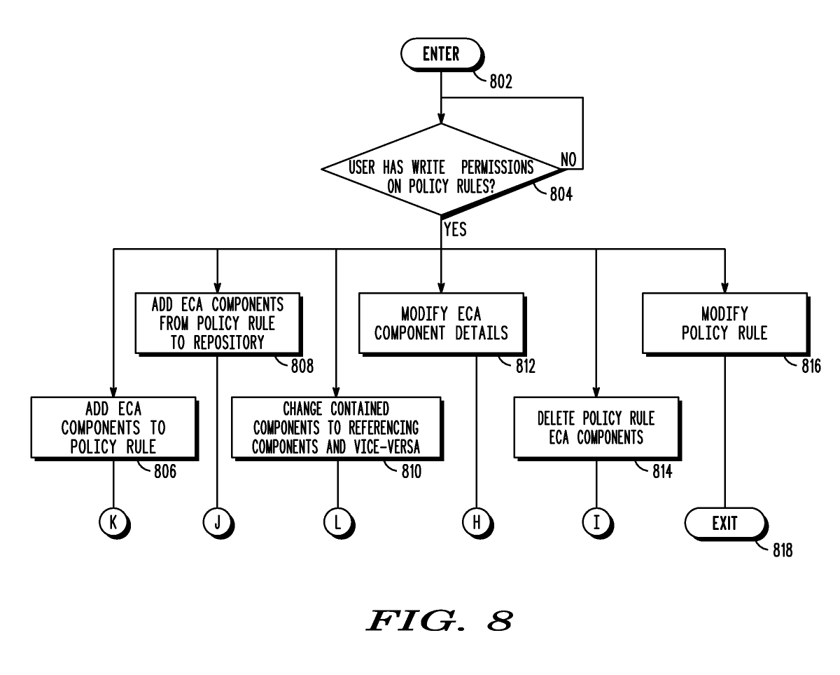

The operational flow diagram of FIG. 5 begins at step 502 and flows directly to step 504. The policy manager 106, at step 504, determines if the user has write permissions on respective policy rule components. If the result of this determination is positive, the user, at step 506, can modify repository policy rule component details, which is discussed in greater detail with respect to FIG. 7. The control then flows to entry point K of FIG. 7. The user, at step 508, can also delete policy rule components that are stored in one or more repositories, which is discussed in greater detail with respect to FIG. 8. The control then flows to entry point L of FIG. 8. If the result of the determination at step 504 is negative, the user is prompted to log in with the necessary credentials and the control flow returns to step 504.

With respect to FIG. 6, the control flows into entry point K. if the user requests to modify policy rule components that are stored in a repository such as the Event repository 112, Condition repository 114, and/or the Action repository 116, the policy manager 106, at step 602, determines if the component is being referenced in a policy rule. If the result of this determination is positive, the policy manager 106, at step 604, notifies the user that the component to be modified is being referenced by a policy rule 110. The policy manager 106 also notifies the user that all changes are reflected in the Referencing components in the policy rule(s) 110 that are Referencing the policy rule component to be modified. The policy manager 106, at step 606, determines if the user still wants to edit the policy rule component. If the result of this determination is negative, the control flow returns to step 602. If the result of this determination is positive, the control flows to step 608.

The user, at step 608, changes the data in a policy rule component. The data can be changed by any appropriate means, including, but not limited to, using a graphical interface, a command line entry, or by modifying a properties file that describes the policy rule component. Changes in a policy rule component can include changing its metadata, details, properties, and the like. The policy manager 106, at step 610, sends a notification to all the policy rules 110 and policy rule components that reference the modified component. Depending on the system settings and the user options, one (or more) of the following occurs: 1) an update is forced on substantially all the policy rules and policy rule components that reference this modified component; 2) the Referencing components can remain out of synch with the changed component; and optionally, 3) the content of the Referenced component that the Referencing component is linked to is copied into the Referencing component, and the Referencing component is changed to a Contained component. Note that option 3) can also be used after option 2) at a later time when an “out-of-synch” component is synchronized with its old Referenced Component. If a component is not updated, it is marked “out-of-synch” and the system warns the user after a successful login that some of the components are out of synch.

A component can remain out-of-synch as long as the user wishes to keep it that way. This is required because a user may be testing a component and may not want to synch immediately. If the user decides to synch at a later time, he/she may do so. In at least some embodiment, the system, has appropriate settings that force the user to synch the Referencing component to the Referenced component after some pre-determined time limit set by a system administrator. If the user does not want to synch with the edited Referenced component after the above time limit expires, then the user converts the Referencing component to a Contained component. Contained components with soft links are also sent notifications as well allowing these components to also be updated.

It should be noted that when a policy rule component is modified, the system stores a version of the policy rule component prior to the start of the editing. This enables the system to undo changes (one embodiment has a system setting controlling how many undo operations are supported, as each undo operation consumes memory). In addition, while modifying policy rule components, the user can also add other policy rule components to the current policy rule component, hence modifying it. For example, an event can be added to the event component, providing the original event additional options to trigger the evaluation of a condition. Similarly, conditions can be added to the existing conditions to incorporate some more checks before taking an Action, and actions can also be added to existing actions to perform additional functions required. The control flow exits at step 612.

With respect to FIG. 7, the control flows into entry point B. The policy manger 106, at step 702, determines if the component to be deleted is being Referenced in a policy rule. If the result of this determination is positive, the policy manager 106, at step 704, notifies the user that the component to be deleted is being Referenced in a policy rule 110 and is possibly an Active policy rule component in the policy rule 110. The policy manager 106, at step 706, determines if the user still wants to delete the policy rule component. If the result of this determination is negative, the control flows back to step 702. If the result of this determination is positive, the control flows to step 708. The user, at step 708, deletes the policy rule component.

The deletion, in one embodiment, can be performed in any appropriate manner, including, but not limited to, using a graphical interface, a command line entry, or by modifying a properties file. The policy manager 106, at step 710, notifies all the Referencing components that reference this deleted component that it has been deleted. Depending on the system settings and user options one (or more) of the following occurs: 1) the Referencing component is deleted immediately; 2) the Referencing component can remain in the system with null references; 3) the Referencing component remains out of synch with the deleted Referenced component, so that even if the Referenced component is deleted the user can use the Referencing Component for testing purposes, until the Referencing component is updated (for this functionality, the policy manager 106 stores the content of the deleted Referenced component); or 4) the content of the Referenced component that the Referencing component is linked to is copied into the Referencing component, and the Referencing component is changed to a Contained component. The additional options that were previously explained in the case of adding policy rule components also apply to this case. The control flow exits at step 712.

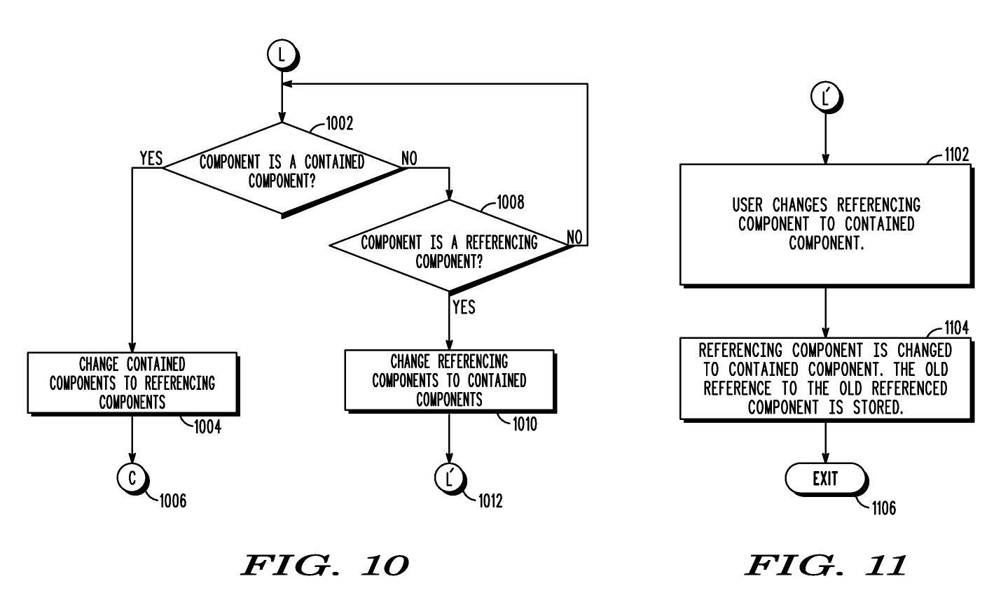

FIG. 10 is an operational flow diagram illustrating examples of editing a policy rule. FIGS. 11-19 are operational flow diagrams illustrating a more detailed discussion of each of the policy rule editing examples in FIG. 10. The operational flow diagram of FIG. 10 begins at step 1002 and flows directly to step 1004. After a user logs into the policy management system 100, the policy manager 106, at step 1004, determines if the user has write permissions associated with any policy rules 110. If the result of this determination is negative, the policy manager 106 notifies the user that the necessary permissions to perform this operation do not exist and the control flow returns to step 1004. If the result of this determination is positive, the policy manager 106 grants one or more of the following editing options to the user.

The user, at step 806, is granted permission to add policy rule components to the policy rule 110. The user, at step 808, is granted permission to add policy rule components from one or more repositories such as the Event repository 112, Condition repository 114, and/or the Action repository 116 (note that each repository, or partition within a repository, may have different permissions). The user, at step 810, is granted permission to change Contained components to Referencing components and vice-versa. The user, at step 812, is granted permission to modify policy rule component details. The user, at step 814, is granted permission to delete policy rule components. The user, at step 816, is granted permission to modify the policy rule 110. The control flow then exits at step 818. Each of these editing options is discussed in greater detail below.

The editing option of modifying the policy rule (816) can include changing the policy rule 110 by changing the meta-data in the policy, as well as changing the set of Events, Conditions, and/or Actions used by the policy rule. In one embodiment, this does not include changing the actual policy rule components, as this is handled in by process above that discussed how “Modify policy rule component Details” process. Modifying a policy rule can be done graphically or textually, as appropriate. The control flow exits after step 816.

A policy rule 110, in one embodiment, may use only some of the policy rule components that it contains and/or refers to. This is because a policy rule is an “intelligent container” and its metadata 224, for example, may be used to specify how the policy rule components are used in a dynamic fashion. The policy rule components that are part of the policy rule 110 and are used are called Active components, while the policy rule components Contained in or Referred by the policy rule 100 but not used by the policy rule are called Inactive components. Both Contained and Referencing components can be either Active or Inactive.

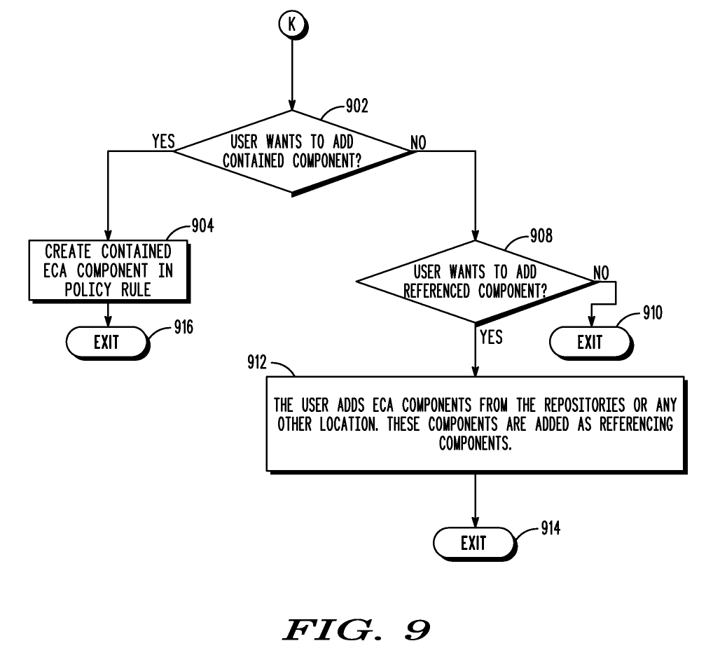

FIG. 9 is an operational flow diagram illustrating a more detailed process of editing a policy rule 90 by adding policy rule components to a policy rule 90. The operational flow diagram of FIG. 9 begins at entry point K and flows directly to step 902. The policy manager 106, at step 902, determines if a user wants to add Contained components. If the result of this determination is positive, the user, at step 904, creates a Contained policy rule component in the policy rule 90. The process for creating a Contained policy rule component in the policy rule 90 has been discussed above with respect to FIG. 2. The control flow then exits at step 906. If the result of this determination is negative, the policy manager 106, at step 908, determines if the user wants to add Referencing component(s). If the result of this determination is negative, the control flow exits at step 910.

If the result of this determination is positive, the policy manager 106, at step 912, creates a Referencing component in the policy rule that references another policy rule component in the Repository or any other location (for example, in another policy rule). This process is transparent to the user. The user adds the policy rule components from one or more repositories such as the Event repository 92, Condition repository 94, and/or the Action repository 96 to the policy rule 90. The components can be added via any appropriate means, including graphical and/or textual user interfaces or scripts. Once the policy rule component from another repository is added as a Referencing component, it can be renamed by the user. Renaming a Referencing component does not have any effect on the component being referenced. To change the details of these components from within the confines of a policy rule 90, these components first need to be changed to a Contained component (of course, they can always be changed directly as discussed in greater detail below). Unless the components exist as Contained components, they generally cannot be changed from within the policy rule editing interface, and instead must be changed directly. The control flow then exits at step 914.

FIGS. 10-14 are operational flow diagrams illustrating a more detailed process of changing a Contained component to Referencing components and vice-versa. FIG. 10 is an operational flow diagram illustrating a process to determine if a user request to change a Contained component to a Referenced component and vice-versa is valid. The operational flow diagram of FIG. 10 begins at entry point L and flows directly to step 1002. A user knows whether a component is a Contained or Referenced component through some form of indication from the system, either graphically using icons, an overlay on the icons, a different font, a textual indication, or a combination of these.

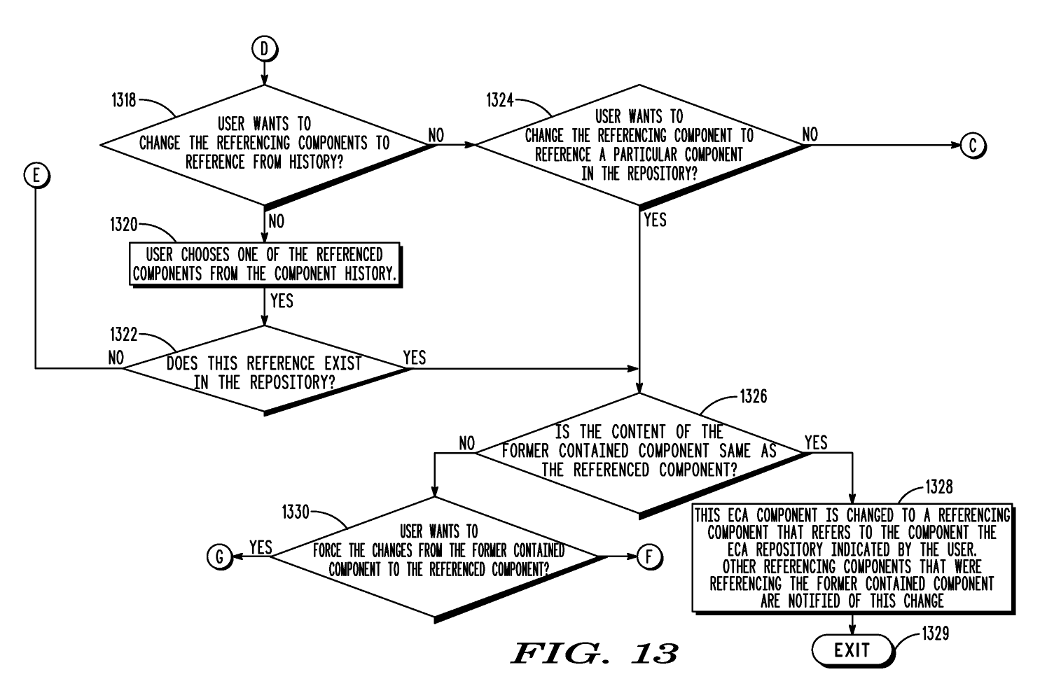

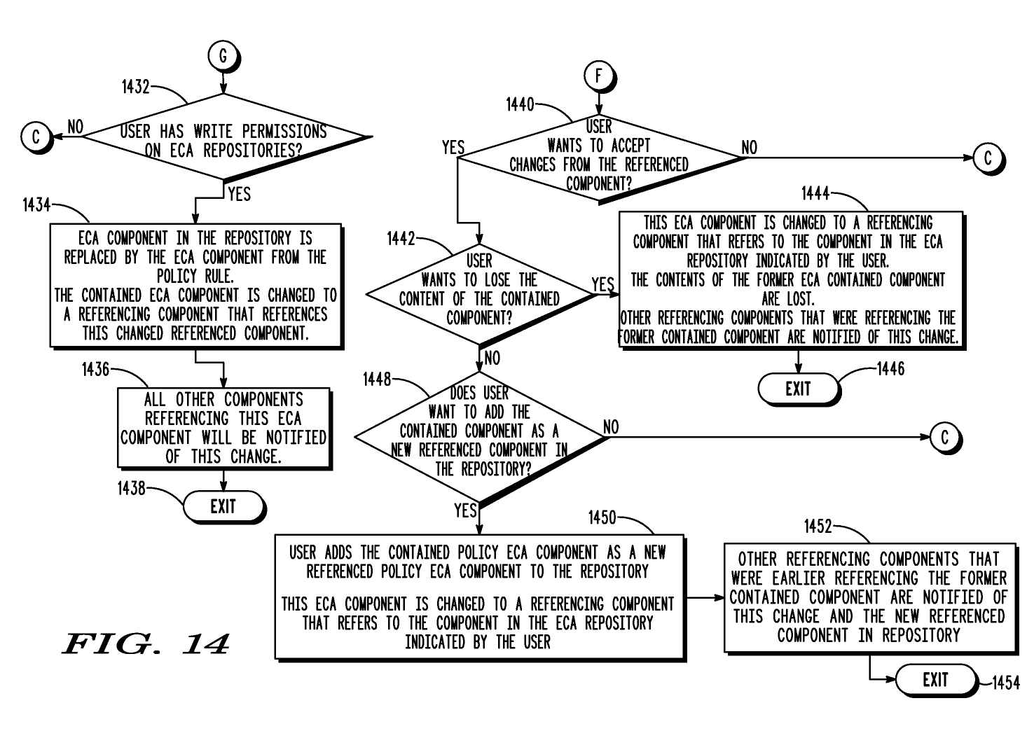

The policy manager 106, at step 1002, determines if the component is a Contained component. If the result of this determination is positive, the Contained components are changed to Referencing components. The control then flows into entry point C of FIG. 14 at step 1006. If the result of this determination is negative, the policy manager 106, at step 1008, determines if the component is a Referencing component. If the result of this determination is negative, the control flows back to step 1002. If the result of this determination is positive the control flows into the entry point L′ of FIG. 13 at step 1006

FIG. 11 is an operational flow diagram illustrating a process for changing a Referencing component to a Contained component. The operational flow diagram of FIG. 11 begins at entry point L′ and flows directly to step 1102. The user, at step 1102, changes the Referencing component to a Contained component via any appropriate means, including graphical and/or textual means. The policy manger 106, at step 1104 uses the current system and user settings to determine whether to simply delete the old reference, or to store (and not delete) the old reference (to the earlier Referenced component), when a Referencing component is changed to a Contained component. Stated differently, the policy manager 106 allows the component to store (and not delete) the old references to the earlier Referenced component. Also note that, in one embodiment, whether the component is allowed to keep track of old references or not, how many references it can keep track of, etc. depend on the user settings. The control flow then exits at step 1106.

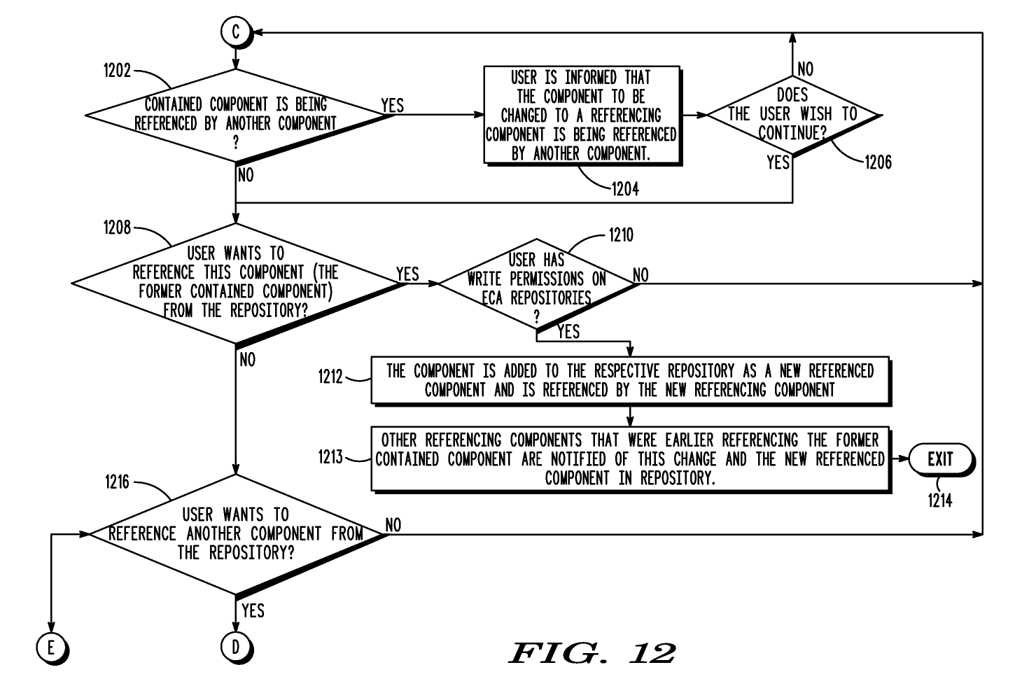

FIG. 12 is an operational flow diagram illustrating a process for changing a Contained component to a Referencing component. FIGS. 13-14 are operational flow diagrams continuing the process discussed with respect to FIG. 12. The operational flow diagram of FIG. 12 begins at entry point C and flows directly to step 1202. The policy manager 106, at step 1202, determines if the Contained component is being referenced by another Referencing component. If the result of this determination is positive, the policy manager 106, at step 1204, notifies the user of the same and given a choice to proceed or rollback. The policy manager 106, at step 1206, determines if the user wants to still continue. If the result of this determination is negative, the control flow returns to step 1202. If the result of this determination is positive, the policy manager 106 chooses what to do next as discussed below.

The Referencing components that are currently referencing the Contained Component being changed, can now change in three different ways, depending on the system setup and the user options: 1) the Referencing components can reference the same component that is being Referenced by the component being changed; 2) the Referencing components can be assigned null references; or 3) the contents of the changed component can be copied to the Referencing components and the Referencing components are changed to Contained components. During the process described in FIG. 124, the components referencing this Contained component are notified of this change.

There are basically two options for the user when changing a Contained component to a Referencing component. The first option is to store the Contained component as a Referenced component in the repository and reference it using the new Referencing component. The second option is to allow the converted Referencing component to reference another component in the repository. If the result of the determination at step 1202 is negative, the policy manager 106, at step 1208, determines if the user wants to reference this component (the former Contained component) from the repository. If the result of this determination is positive, the policy manager 106, at step 1210, determines if the user has write permissions on ECA repositories.

If the result of the determination at step 1210 is negative, the control flow returns to step 1202. If the result of this determination is positive, the policy manager 106, at step 1212, adds the details of this component to the repository as a new Referenced component and allows the changed component to reference the component in the repository. To clarify, if the user is trying to change the Contained component “Component A” to a Referencing Component, the system creates a new component called “Component B” in the repository which is a copy of Component A and then changes Component A to a Referencing component that points to Component B.

Other Referencing Components that were referencing the changed Contained Component, at step 1213, are notified of this change and the new Referenced component in the repository. Depending on the system and user setting, these Referencing components can be changed as described in section [00108] above. The control flow exits at step 1214.

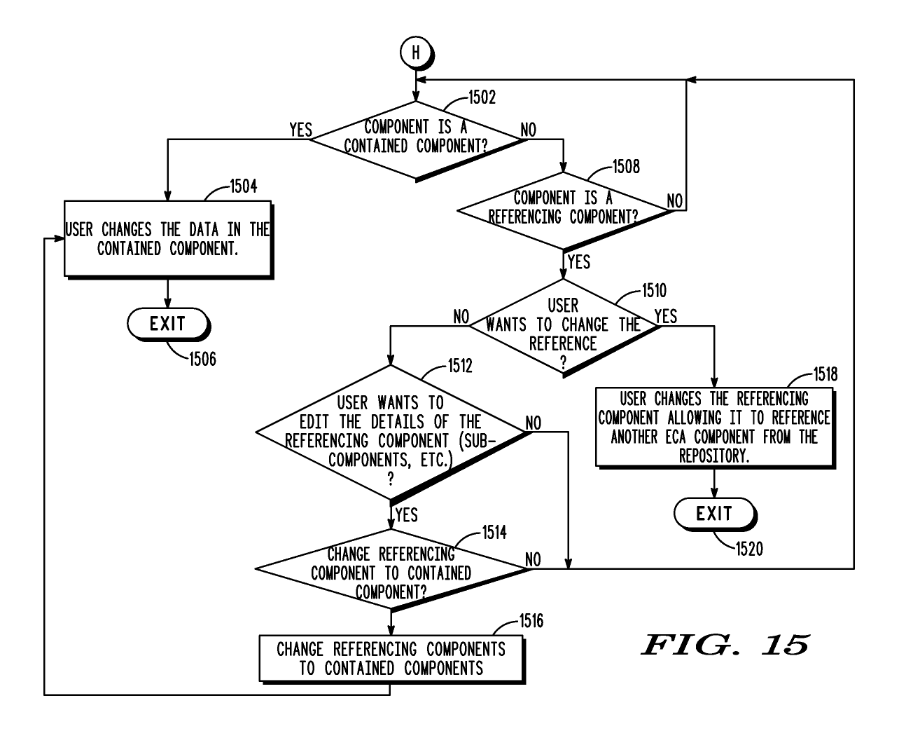

If the result of the determination at step 1208 is negative, the policy manager 106, at step 1216, determines if the user wants to reference another component from the repository. Note that this other component can be a component that was earlier being referenced by the Contained Component being changed, a different Referenced component in the repository; or a policy rule 110 since a policy rule 110 can hold Contained components that can be referenced by other Referencing components. If the result of this determination is negative, the control flows back to step 1202. If the result of this determination is positive, the control flows to entry point D of FIG. 15.

The policy manager 106, at step 1318, determines if the user wants to allow the changed Referencing Component to reference one of the older Referenced components from its history. Every component keeps a history of all the components it had referenced earlier. The system and user settings determine how much history information is stored, but every component at least “knows” of the last component it had referenced. The determination at step 1318 is especially useful if a component that was originally a Referencing Component was converted to a Contained Component was testing purposes and is again required to be changed to a Referenced component for synching with the old Referenced component and pulling in changes made to it. It should be noted that, in one embodiment, a user can synchronize a Contained component. Doing so allows a user to avoid having to change the Contained component to a Referencing component and vice-versa.

If the result of the determination at step 1318 is positive, the policy manager 106, at step 1320, allows the user to choose one of the Referenced components from the component history. The policy manager 106, at step 1322, determines if the reference exists in the repository. If the result of this determination is negative, the control flow returns to entry point E of FIG. 14. If the result of this determination is positive, the policy manager 106, at step 1326, determines if the content of the Contained Component, that is being changed, is the same as the Referenced component that it is going to reference. This determination is required to find out any contention that needs to be resolved.

If the result of the determination at step 1326 is positive, the policy manger 106, at step 1328, changes the Contained ECA component to a Referencing Component that references the component indicated by the user. Other Referencing Components that were referencing the former Contained Component are notified of this change. The process then exits at step 1329. If the result of the determination at step 1326 is negative, contention resolution kicks in, and the policy manger 106, at step 1330, determines if the user wants to force the changes from the Contained Component to the Referenced component. Essentially, the user has two options for resolving contention, either push the changes from the Contained Component being changed to the new Referenced component, or accept the changes from the Referenced component.

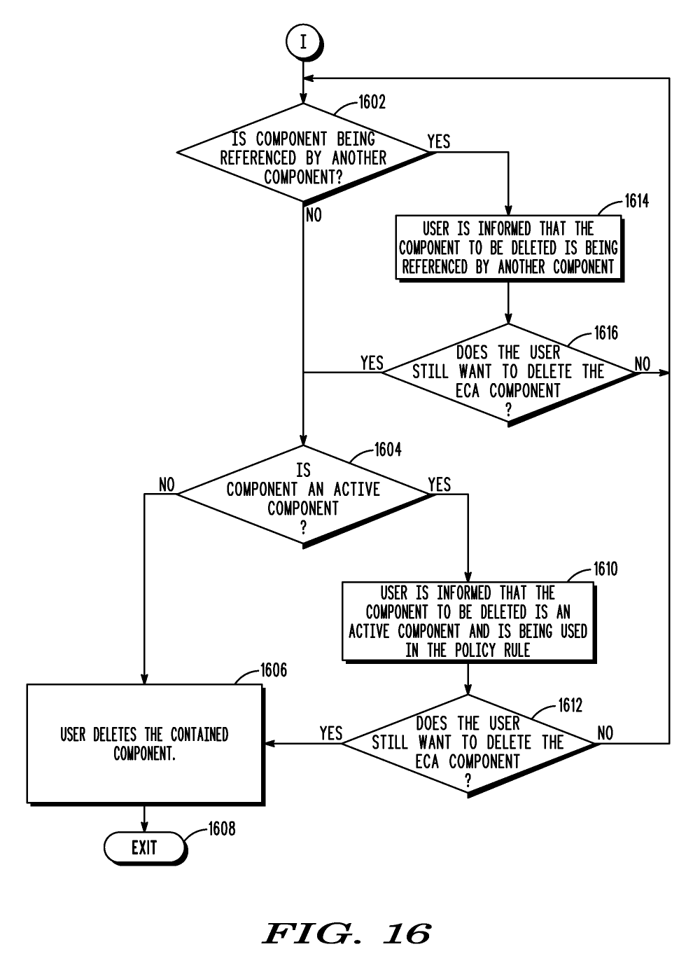

If the result of the determination at step 1330 is positive, the control flows to entry point G of FIG. 16. If the result of the determination at step 1330 is negative, the control flows to entry point F of FIG. 16. Returning back to step 1318. If the result of this determination is negative, the policy manager 106, at step 1324 determines if the user wants to allow the changed Referencing component to reference a particular component in the repository. If the result of this determination is negative, the control flows back to entry point C of FIG. 12. If the result of this determination is positive, the control flows to step 1326.

Turning now to FIG. 14, the control flows into entry point G after a negative decision at step 1320 of FIG. 13. The policy manager 106, at step 1332, determines if the user has the necessary permissions to change the ECA Component in the repository. If the result of this determination is negative, the control returns to entry point C of FIG. 12. If the result of this determination is positive, the ECA Component in the repository, at step 1434, is replaced by the Contained ECA Component. The Contained ECA component in the Policy Rule is changed to a Referencing Component that references this changed ECA Component. The policy manager 106, at step 1436, notifies all other component referencing this changed Referenced component of this change. The control flow then exits at step 1438.

With respect to entry point F, the policy manager 106, in step 1440, determines if the user wants to accept changes from the Referenced component. If the result of this determination is negative, the control flow returns to entry point C of FIG. 12. If the result of this determination is positive, the policy manager 106, at step 1442, determines if the user wants to lose all the content of the Contained Component that is being changed. If the result of this determination is positive, the Contained ECA Component, at step 1444, is changed to a Referencing Component that refers to the component in the ECA repository indicated by the user in step 1444. Other Referencing Components that were referencing the former Contained Component are notified of this change. The content of the former Contained Component is lost. The process exits in step 1446.

If the result of the determination at step 1442 is negative, the policy manager 106, in step 1448, determines if the user wishes to add the Contained component as new Referenced component in the repository so that the contents of the Contained Component are not lost. If the result of this determination is negative, the control flow returns entry point C of FIG. 14.

If the result of the determination at step 1448 is positive, the Contained component, at step 1450, is added as a new ECA Component to the repository and the Contained ECA Component is changed to a Referencing Component that refers to the ECA Component indicated by the user. The policy manager 106, at step 1452, notifies other Referencing Components that were earlier referencing the former Contained Component of this change and of the new Referenced component in Repository. The process exits in step 1454.

FIG. 15 is an operational flow diagram illustrating a more detailed process for modifying a policy rule component in a policy rule. The operational flow diagram of FIG. 15 begins at entry point H and flows directly to step 1502. A component in a policy rule 110, in one embodiment, can only by modified in the “policy rule editing area” if it is a Contained component. Therefore, the policy manager 106, at step 1502, determines if the component is a Contained component. If the result of this determination is positive, the user, at step 1504, changes the data in the Contained component by any appropriate means, including but not limited to using a graphical, textual, or scripting interface. The changes that a user can make to a Contained component include changing the metadata, details, properties, and sub-components of the component. The control flow exits at step 1506.

If the result of the determination at step 1502 is negative, the policy manager 106, at step 1508, determines if the component is a Referencing component. If the result of this determination is negative, the control flows to step 1502. The only change that user can make to a Referencing component (in the “policy rule editing area”) is changing the reference (i.e., the user can make the Referencing component reference a different component in repository). Therefore, if the result of this determination is positive, the policy manager 106, at step 1510, determines if the user wants to change the reference (e.g., make the Referencing component reference another policy rule component).

If the result of this determination is negative, the policy manager 106, at step 1512, determines if the user wants to edit the details of the Referencing components, sub-components, or the like. If the result of this determination is negative, the control flow returns back to step 1502. If the result of this determination is positive, the policy manager 106, at step 1514, determines if the user wants the component to be changed to a Contained component (since a user can make these changes only to a Contained component).

If the result of this determination is negative, the control flow returned to step 1502. If the result of this determination is positive, the process in FIG. 11 is used to change the Referencing component to a Contained component at step 1516. Once, the component is converted to a Contained component the user can make the required changes to the details of that component. The control flow returns to step 1504. Returning back to step 1510, if this determination is positive, the user, at step 1518, changes the Referencing component allowing it to reference another policy rule component from the repository. The control flow exits at step 1520.

FIG. 16 is an operational flow diagram illustrating a more detailed process for deleting policy rules and policy rule components. The operational flow diagram of FIG. 16 begins at entry point I and flows directly to step 1602. The policy manager 106, at step 1602 determines if the component is being referenced by another component. If the result of this determination is negative, the policy manager 106, at step 1604, determines if the component is an active component. An Active component is a component that is being used in the policy rule 110, while an Inactive component in a policy rule 110 is a component that is stored in the policy rule 110, but is not currently being used by the policy rule 110.

The concept of Active and Inactive component exists because, when creating a policy rule 110 via one or more embodiments discussed above, users have an option of gathering all the components that they need before orchestrating the behavior packaged by the policy rule 110 that uses those components. This does not preclude the option of adding policy rule components on the fly while creating a policy rule 110. Instead, it allows a group of users to collaborate in a systematic way. A user is able to keep a set of optional components in the policy rule 110, so that the user can swap out components in the policy rule 110 with other components while testing to try different algorithms, improve performance, and the like. While Inactive Components can be deleted without any impact on the system (provided they are not referenced by another component), deleting an Active component may cause the policy rule 110 using it to behave incorrectly.

If the result of the determination at step 1604 is negative, the user, at step 1606, deletes the Contained component. The control flow exits at step 1608. If the result at step 1604 is positive, the policy manager 106, at step 1610, notifies the user that the component to be deleted is an active component and is being used in the policy rule 110. The policy manger 106, at step 1612, determines if the user still wants to delete the policy rule component. If the result of this determination is negative, the control flows back to step 1602. If the result of this determination is positive, the control flows to step 1606. Returning to step 1602, if the result of this determination is positive, the policy manager 106, at step 1614, notifies the user that the component to be deleted is being referenced by another component.

The policy manger 106, at step 1618, determines if the user still wants to delete the policy rule component. If the result of this determination is negative, the control flows back to step 1602. If the result of this determination is positive, the control flows to step 1604. It should be noted that if the deleted component is a Referencing component, the Referenced component is notified of this deletion. If the deleted component is a Referenced component (a Contained component that is being referenced by other components in the system), all the Referencing components are notified of this deletion as discussed above with respect to FIG. 8. If the deleted component is an Active Component, the policy rule 110 is notified of the deletion.

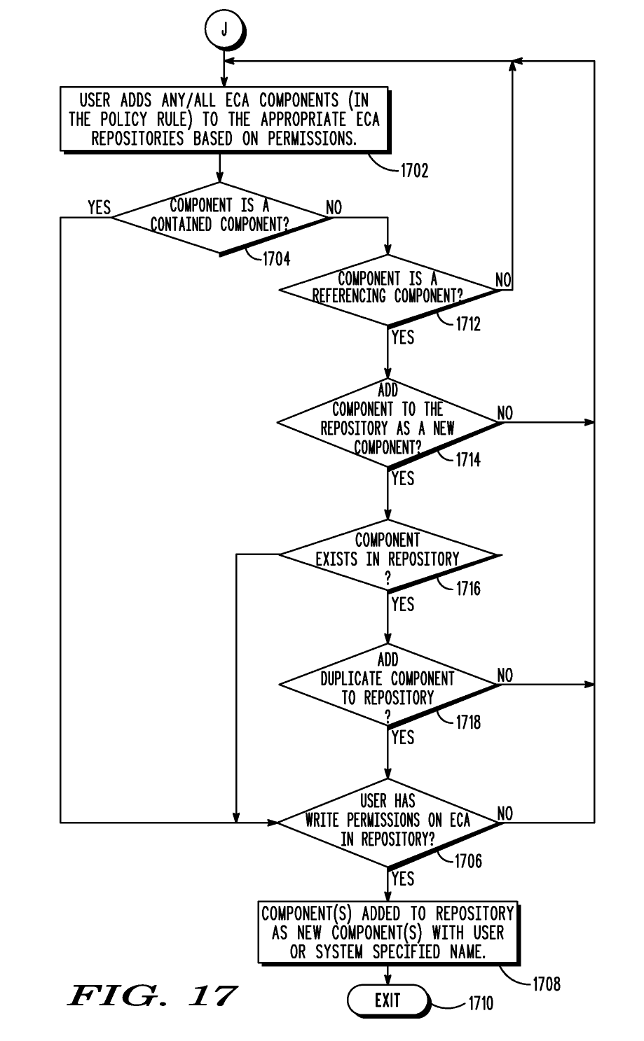

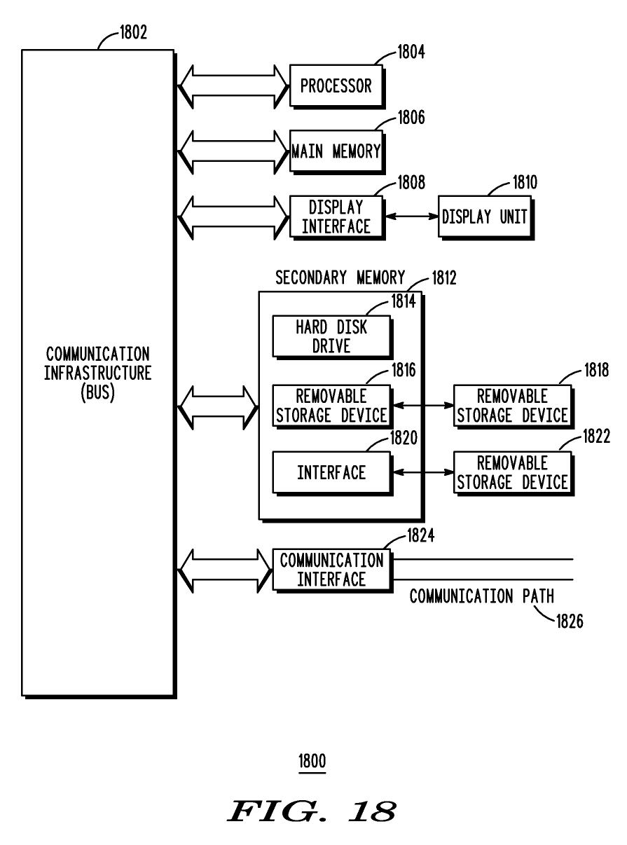

FIG. 17 is an operational flow diagram illustrating a more detailed process for adding a policy rule component from the policy rule to a repository. The operational flow diagram of FIG. 17 begins at entry point J and flows directly to step 1702. A user, at step 1702, attempts to add any/all policy rule components (in the policy rule) to the appropriate repositories based on his or her permissions. The policy manager 106, at step 1704, determines if the component is a Contained component. If the result of this determination is positive, the policy manager 106, at step 1720, determination if the user has write permissions for policy rule components in the associated repositories. If the result of this determination is negative, the control flow returns to step 1702. If the result of this determination is positive, the policy manager 106, at step 1706, adds the components to the repositories as new components with the user or system specified name. The control flow then exits at step 1710.

If the result of the determination at step 1704 is negative, the policy manager 106, at step 1712, determines if the component is a Referencing component. If the result of this determination is negative, the control flow returns to step 1702. If the result of this determination is positive, the policy manager 106, at step 1714, determines if the user wants to add the component to the repository as a new component. If the result of this determination is negative, the control flow returns to step 1702. If the result of this determination is positive, the policy manager 106, at step 1716, determines if the component already exits in the repository. If the result of this determination is negative, the control flows to step 1706. If the result of the determination is positive, the policy manager 106, at step 1718, determines if the user wants to add a duplicate component (with a different name) to the repository. If the result of this determination is negative, the control flow returns to step 1702. If the result of this determination is positive, the control flows to step 1706.

An advantage of the various embodiments of the present invention is that policy rules 110 and their associated components can be efficiently managed. When the user creates a policy rule 110, he/she has the option of specifying which Event(s) 118, Condition(s) 120, and Action(s) 122 are to be included. Whenever a policy rule 110 is created, it only includes placeholders for a single policy Event, a single policy Condition, and a single policy Action. There is no metadata or information about how the policy rule components are orchestrated to form the policy rule 110, since that information is specific to each policy rule 110. The next step is to follow the process discussed above with respect to FIG. 9 and modify or edit the policy rule 110 to orchestrate the Events, Conditions, and Actions.

It should be noted that a template of a policy rule or a Policy Component is essentially the policy rule 110 or the component itself which is available to the user as a template. Creating a template for a policy rule 110 and policy rule components is similar to creating policy rules discussed above and for creating policy rule components discussed above. After a user has created a policy rule 110 or a policy rule component, the user has the option of making the policy rule 110 or policy rule component available as a template. Once the user chooses this option, the system makes that policy rule 110 or policy rule component available as a template. This allows the user to create a component which is identical to the template and customize it according to his/her needs.

It should also be noted that using a template to create a policy rule 110 is substantially similar to creating a Policy as discussed above. When creating a policy rule 110, the user has an option of creating a new policy rule 110 or using a template. If the user chooses to use the template, then he is allowed to choose from a set of templates available. After choosing the template, the system loads all the necessary Events 118, Conditions 120, and Actions 122 required for the template and creates a policy rule 110 that is a copy of the chosen template. The user can now edit and customize this new policy rule 110 according to his or her needs.

A substantially similar process is used for creating policy rule components using a template. The user starts creating a policy rule 110 component as discussed above. While doing this, the user has the option of creating a new policy rule component using a template. If the user chooses to use the template, the user is allowed to choose from a set of templates available for that policy rule component type. The system then creates a policy rule component which is an identical copy of the chosen template, but with a different name. The user can now edit and customize this policy rule component according to his or her needs.

Information Processing System

FIG. 18 is a high level block diagram illustrating a detailed view of a computing system 1800 useful for implementing the policy manager 106 according to embodiments of the present invention. The computing system 1800 is based upon a suitably configured processing system adapted to implement an exemplary embodiment of the present invention. For example, a personal computer, workstation, or the like, may be used.

In one embodiment of the present invention, the computing system 1800 includes one or more processors, such as processor 1804. The processor 1804 is connected to a communication infrastructure 1802 (e.g., a communications bus, crossover bar, or network). Various software embodiments are described in terms of this exemplary computer system. After reading this description, it becomes apparent to a person of ordinary skill in the relevant art(s) how to implement the invention using other computer systems and/or computer architectures.

The computing system 1800 can include a display interface 1808 that forwards graphics, text, and other data from the communication infrastructure 1802 (or from a frame buffer) for display on the display unit 1810. The computing system 1800 also includes a main memory 1806, preferably random access memory (RAM), and may also include a secondary memory 1812 as well as various caches and auxiliary memory as are normally found in computer systems. The secondary memory 1812 may include, for example, a hard disk drive 1814 and/or a removable storage drive 1816, representing a floppy disk drive, a magnetic tape drive, an optical disk drive, etc. The removable storage drive 1816 reads from and/or writes to a removable storage unit 1818 in a manner well known to those having ordinary skill in the art.

Removable storage unit 1818, represents a floppy disk, a compact disc, magnetic tape, optical disk, etc. which is read by and written to by removable storage drive 1816. As are appreciated, the removable storage unit 1818 includes a computer readable medium having stored therein computer software and/or data. The computer readable medium may include non-volatile memory, such as ROM, Flash memory, Disk drive memory, CD-ROM, and other permanent storage. Additionally, a computer medium may include, for example, volatile storage such as RAM, buffers, cache memory, and network circuits. Furthermore, the computer readable medium may comprise computer readable information in a transitory state medium such as a network link and/or a network interface, including a wired network or a wireless network that allow a computer to read such computer-readable information.

In alternative embodiments, the secondary memory 1812 may include other similar means for allowing computer programs or other instructions to be loaded into the policy manager 106. Such means may include, for example, a removable storage unit 1822 and an interface 1820. Examples of such may include a program cartridge and cartridge interface (such as that found in video game devices), a removable memory chip (such as an EPROM, or PROM) and associated socket, and other removable storage units 1822 and interfaces 1820 which allow software and data to be transferred from the removable storage unit 1822 to the computing system 1800.

The computing system 1800, in this example, includes a communications interface 1824 that acts as an input and output and allows software and data to be transferred between the policy manager 106 and external devices or access points via a communications path 1826. Examples of communications interface 1824 may include a modem, a network interface (such as an Ethernet card), a communications port, a PCMCIA slot and card, etc. Software and data transferred via communications interface 1824 are in the form of signals which may be, for example, electronic, electromagnetic, optical, or other signals capable of being received by communications interface 1824. The signals are provided to communications interface 1824 via a communications path (i.e., channel) 1826. The channel 1826 carries signals and may be implemented using wire or cable, fiber optics, a phone line, a cellular phone link, an RF link, and/or other communications channels.

In this document, the terms “computer program medium,” “computer usable medium,” and “computer readable medium” are used to generally refer to media such as main memory 1806 and secondary memory 1812, removable storage drive 1816, a hard disk installed in hard disk drive 1814, and signals. The computer program products are means for providing software to the computer system. The computer readable medium allows the computer system to read data, instructions, messages or message packets, and other computer readable information from the computer readable medium.

Computer programs (also called computer control logic) are stored in main memory 1806 and/or secondary memory 1812. Computer programs may also be received via communications interface 1824. Such computer programs, when executed, enable the computer system to perform the features of the various embodiments of the present invention as discussed herein. In particular, the computer programs, when executed, enable the processor 1804 to perform the features of the computer system.

Non-Limiting Examples

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. A method for modifying policy elements, the method on an information processing system comprising:
retrieving at least one reusable policy element from at least one repository, wherein the reusable policy element comprises at least one of:
a reusable policy rule,
a reusable policy rule component,
a reusable policy rule template, and
a reusable policy rule component templates; and
modifying the reusable policy element by one of:
editing the reusable policy element, and
deleting the reusable policy element.

2. The method of claim 1, wherein the editing further comprises
editing the reusable policy element to define metadata associated therewith, wherein
the metadata defines at least one behavior required by the reusable policy element, and wherein the metadata indicates at least one repository in which the reusable policy element is to be stored, and wherein
the behavior at least indicates how the reusable policy element interacts with at least one other reusable policy element in the at least one repository.

3. The method of claim 1, wherein the editing further comprises:
editing the reusable policy element to remove metadata, wherein removal of metadata replaces existing metadata with default metadata corresponding to a reusable policy element type associated with the reusable policy element being edited.

4. The method of claim 1, wherein the editing further comprises:
editing the reusable policy element for defining content associated with the reusable policy element, wherein the defining includes
defining a structure of the reusable policy element according to syntactic rules associated with at least one of an information processing system and a language being used to edit the reusable policy element; and
at least one of adding and modifying policy rule components, wherein the policy rule components are at least one of referenced policy rule components, contained policy rule components, and policy rule component templates.

5. The method of claim 1, wherein the editing further comprises:
defining content, wherein the defining includes:
defining a structure of the reusable policy element according to syntactic rules of at least one of an information processing system and a language being used to edit the reusable policy element; and
at least one of adding and modifying elements of at least one of a referenced policy rule component, a contained policy rule component and a policy rule component template.

6. The method of claim 1, wherein the editing further comprises:
editing the reusable policy element to remove content associated with the reusable policy element, wherein the content is at least one of:
a set of referenced policy rule components;
a set of contained policy rule components; and
a set of policy rule component templates.

7. The method of claim 6, wherein policy rule components include at least one of Metadata;
Events;
Conditions; and
Actions.

8. The method of claim 1, wherein the editing further comprises:
editing the reusable policy element to remove content associated with the reusable policy element, wherein the content is at least one of:
at least one element used to create a referenced policy rule component;
at least one element used to create a contained policy rule component; and
at least one element used to create a policy rule component template.

9. The method of claim 1, wherein deleting the reusable policy element further comprises:
deleting at least one of a reusable policy rule, a reusable policy rule component, a reusable policy rule template, and a reusable policy rule component template included in the reusable policy element.

10. A method for modifying policy elements, the method on an information processing system comprising:
retrieving at least one reusable policy element from at least one repository, wherein the reusable policy element comprises at least one of:
a reusable policy rule,
a reusable policy rule component,
a reusable policy rule template, and
a reusable policy rule component template; and
changing at least one referencing policy rule component
to a contained policy rule component.

11. The method of claim 10, wherein the referencing policy rule component is fully defined within at least one of,
the reusable policy element; and
outside of the reusable policy element in a different repository than the at least one repository, and
wherein the contained policy rule component is fully defined within at least one of,
the reusable policy element; and
outside of the reusable policy element in a different repository than the at least one repository.

12. The method of claim 10, wherein the contained policy rule component stores prior references to a referenced policy rule component that the contained policy rule component was referencing before the contained policy rule component was changed from a referencing policy rule component to the contained policy rule component.

13. The method of claim 10, further comprising at least one of:
changing at least one referencing policy rule component to identify and reference a new reusable policy rule component, wherein the new reusable policy rule component is fully defined within at least one of,
the reusable policy element; and
outside of the reusable policy element in a different repository than the at least one repository comprising the reusable policy element;
and
changing at least one referencing policy rule component within the reusable policy element to reference an existing policy rule component that was previously being referenced by the referencing policy rule component currently being changed.

14. The method of claim 13, wherein the referencing policy rule component that has been changed stores references to a previously referenced policy rule component that the referencing policy rule component was referencing before being changed.

15. The method of claim 14, further comprising:
receiving a specification of a number of references to the previously referenced policy rule components that can be stored by a reusable policy rule component.

16. The method of claim 10, further comprising:
changing at least one contained policy rule component to a referencing policy rule component, wherein the referencing policy rule component references at least one policy rule component; and
changing the at least one contained policy rule component to a referencing policy rule component, wherein the referencing policy rule component references a previously existing policy rule component that was previously being referenced by the contained policy rule component.

17. The method of claim 10, further comprising at least one of:
identifying at least one referencing policy rule component that resides in at least one reusable policy element, wherein the referencing policy rule component references a reusable policy rule component that has been edited, wherein editing of the reusable policy rule component facilitates at least one of:
providing a programmable number of changes that are reversible;
storing a version of a non-synchronized referenced policy rule component when an editing operation begins, wherein the version is an original version that is prior to any modifications to the reusable policy rule component;
storing an original version of the reusable policy rule component that has been edited prior to editing being performed;
receiving a selection from one of a human user and machine user,
wherein the selection is for one of the following:
changing the referencing policy rule component to a contained policy rule component with pre-edit content;
synchronizing the referencing policy rule component with a set of edits made to the reusable policy rule component; and
updating the referencing policy rule component so that it does not refer to any referenced policy rule components and marking the referencing policy rule component as out of sync; and
sending a message regarding the reusable policy rule component that has been edited to all referencing policy rule components that reference the reusable policy rule component that has been edited, wherein the message informs the referencing policy rule components that have received the message of an edit that has been done to reusable policy rule component.

18. The method of claim 17, wherein the message being sent to the referencing policy rule components is specified at one of initialization and runtime of a system being used to edit the reusable policy rule component to be one of a condensed message indicating that a change has been made and an elaborate message comprising details of a set of changes that have been made to the reusable policy rule component.

19. The method of claim 17, wherein marking the referencing policy rule component further comprises:
enabling one of a user and a system to select between at least one:
forcing non-synchronized referenced policy rule components and referencing policy rule components to have changes associated with editing the reusable policy rule component synchronized and stored in repositories associated with each of the referenced policy rule components and referencing policy rule components, respectively;
forcing a conversion of at least one non-synchronized referencing policy rule component to a contained policy rule component with content stored from a referenced policy rule component which was previously referenced.

20. The method of claim 17, wherein marking the referencing policy rule component as out of sync further comprises:
checking a programmable time limit set by a system administrator that governs when synchronization of all referencing components impacted by editing of the reusable policy rule component is to be finished.

21. The method of claim 16, further comprising:
determining that the contained policy rule component comprises a prior reference to a policy rule component that currently exists in a policy rule component repository;
determining that a user is requesting to replace the contained policy rule component with the policy rule component associated with the prior reference; and
changing the contained policy rule component to a referencing policy rule component that refers to the policy rule component associated with the prior reference.

22. The method of claim 16, further comprising:
determining that the contained component policy that has been changed failed to be a referencing component;
adding the contained policy rule component to at least one policy rule component repository in a plurality of policy rule component repositories; and
changing the contained component into a referencing component.

23. The method of claim 16, further comprising:
determining that the at least one contained policy rule component is to be changed to a referencing policy rule component that references a different policy rule component that already exists in the policy rule component repository.

24. The method of claim 16 further comprising:
determining that the contained component policy comprises a prior reference to a policy rule component that currently exists in a policy rule component repository;
determining if a set of contents of the prior reference are different than a current set contents of the contained policy rule component, wherein determining if a set of contents of the prior reference are different than a current set contents of the contained policy rule component further comprises at least one of:
determining that the set of contents of the prior reference are equal to the current set of contents,
wherein in response to the set of contents of the prior reference and the current set of contents being equal
changing the contained component to a referencing component pointing to the prior reference;
determining that the set of contents of the prior reference fail to be equal to the current set of contents,
wherein in response to the set of contents of the prior reference and the current set of contents failing to be equal
performing at least one of
replacing the prior reference with the current set of contents of the contained policy rule component; and
discarding the current set of contents of the contained policy rule component and changing the contained policy rule component to a referencing component that references the prior reference.
